(19) United States
(12) Patent Application Publication
(10) Pub. No.: US 2025/0080226 A1
(43) Pub. Date: Mar. 6, 2025

(54) OPTICAL REPEATER, OPTICAL REPEATING METHOD, AND PROGRAM

(71) Applicant: NEC Corporation, Tokyo (JP)

(72) Inventors: Shoma TATENO, Tokyo (JP); Hidemi NOGUCHI, Tokyo (JP)

(73) Assignee: NEC Corporation, Tokyo (JP)

(21) Appl. No.: 18/816,267

(22) Filed: Aug. 27, 2024

(30) Foreign Application Priority Data
Sep. 6, 2023 (JP) 2023-144647

(51) Int. Cl. H04B 10/291

(52) U.S. Cl. CPC H04B 10/291

(57) ABSTRACT

An optical repeater of an optical network system performs chromatic dispersion compensation processing on an electrical signal based on a received optical signal, the processing being based on a carrier frequency and frequency band of the relevant channel among a plurality of channels included in the optical signal; and phase conjugation processing on the electrical signal based on the received optical signal.

This application is based upon and claims the benefit of priority from Japanese patent application No. 2023-144647, filed on Sep. 6, 2023, the disclosure of which is incorporated herein in its entirety by reference.

### TECHNICAL FIELD

The present disclosure relates to an optical repeater, an optical repeating method, and a program.

### BACKGROUND ART

In recent years, 5G wireless communication systems have been introduced, and in the post-5G era, there is a growing demand for high-capacity communication, ultra-high speed, ultra-low latency, and many simultaneous connections, not only in wireless communication but also in the field of optical communication. For this reason, research is being conducted on optical communication systems with the expectation that they will be used for various communication services and industrial applications.

For example, in backbone optical communication systems, digital coherent systems combining optical phase modulation systems and polarization multiplexing and separation technologies are used to achieve capacities in excess of 100 Gbps. In addition, research and development of transmission systems that improve frequency utilization efficiency and enable multiple simultaneous connections by narrowing the signal bandwidth and using wavelength division multiplexing (WDM) is also underway. Research and development are also being conducted on distortion compensation technology that uses optical or digital signal processing to compensate for signal distortion that occurs during optical transmission, such distortion hindering high-capacity communications due to high baud rates and high multi-level signal modulation in optical communication systems.

Related technology is known, for example, from U.S. Patent Application Publication No. 2012/0224855, which discloses the connection of an optical phase conjugation device that generates phase conjugated signals by digital signal processing between a transmitter and a receiver.

In technologies related to optical network systems as described above, it is required to suppress the degradation of signal quality due to nonlinear distortion in optical transmission.

### SUMMARY

The purpose of the present disclosure is to provide an optical network system, a control method, a control program, a control device, and an optical repeater that solve the above-mentioned problem.

An optical repeater according to the present disclosure includes at least one memory configured to store instructions; and at least one processor configured to execute the instructions to: perform chromatic dispersion compensation processing on an electrical signal based on a received optical signal, the processing being based on a carrier frequency and frequency band of a relevant channel among a plurality of channels included in the optical signal; and perform phase conjugation processing on the electrical signal based on the received optical signal.

An optical repeating method according to the present disclosure performs chromatic dispersion compensation processing on an electrical signal based on a received optical signal, the processing being based on a carrier frequency and frequency band of the relevant channel among a plurality of channels included in the optical signal, and performs phase conjugation processing on the electrical signal based on the received optical signal.

A non-transitory storage medium storing a program according to the present disclosure causes an optical repeater to execute a chromatic dispersion compensation processing means that performs chromatic dispersion compensation processing on an electrical signal based on a received optical signal, the processing being based on a carrier frequency and frequency band of the relevant channel among a plurality of channels included in the optical signal, and a phase conjugation processing means that performs phase conjugation processing on the electrical signal based on the received optical signal.

According to the present disclosure, signal quality degradation due to nonlinear distortion in optical transmission can be suppressed.

### BRIEF DESCRIPTION OF THE DRAWINGS

FIG. 1 is a configuration diagram showing a configuration example of an optical network system according to a basic example.

FIG. 2 is a configuration diagram showing a configuration example of an optical repeater according to a basic example.

FIG. 3 is a configuration diagram showing a configuration of the optical transmitter/receiver according to the present disclosure.

FIG. 4A is a diagram for illustrating the challenges of the optical transmitter/receiver according to the present disclosure.

FIG. 4B is a diagram for illustrating the challenges of the optical transmitter/receiver according to the present disclosure.

FIG. 5 is a configuration diagram showing the outline configuration of the control system according to the present disclosure.

FIG. 6 is a configuration diagram showing the outline configuration of the optical repeater according to the present disclosure.

FIG. 7 is a configuration diagram showing an example configuration of an optical network system according to one example embodiment of this disclosure.

FIG. 8 is a configuration showing a configuration example of each device in an optical network system according to one example embodiment of the present disclosure.

FIG. 9A is a conceptual diagram showing a specific example of carrier frequency control by a control method in accordance with one example embodiment of this disclosure.

FIG. 9B is a conceptual diagram showing a specific example of carrier frequency control by a control method in accordance with one example embodiment of this disclosure.

FIG. 9C is a conceptual diagram showing a specific example of carrier frequency control by a control method in accordance with one example embodiment of this disclosure.

FIG. 10 is a configuration showing a configuration example of each device in an optical network system according to one example embodiment of the present disclosure.

FIG. 11 is a configuration diagram showing an example configuration of the chromatic dispersion compensation portion according to one example embodiment of this disclosure.

FIG. 12A is a conceptual diagram that shows a specific example of chromatic dispersion compensation according to one example embodiment of this disclosure.

FIG. 12B is a conceptual diagram that shows a specific example of chromatic dispersion compensation according to one example embodiment of this disclosure.

FIG. 13 is a flowchart showing an example of the operation of an optical network system according to one example embodiment of this disclosure.

FIG. 14A is a diagram that shows a specific example of chromatic dispersion compensation by a control method according to one example embodiment of this disclosure.

FIG. 14B is a diagram that shows a specific example of chromatic dispersion compensation by a control method according to one example embodiment of this disclosure.

FIG. 14C is a diagram that shows an overview of the phase conjugation processing according to one example embodiment of this disclosure.

FIG. 15 is a diagram that shows a specific example of chromatic dispersion compensation by a control method according to one example embodiment of this disclosure.

FIG. 16A is another diagram that shows a specific example of chromatic dispersion compensation by a control method according to one example embodiment of this disclosure.

FIG. 16B is another diagram that shows a specific example of chromatic dispersion compensation by a control method according to one example embodiment of this disclosure.

FIG. 17A is another diagram that shows a specific example of chromatic dispersion compensation by a control method according to one example embodiment of this disclosure.

FIG. 17B is another diagram that shows a specific example of chromatic dispersion compensation by a control method according to one example embodiment of this disclosure.

FIG. 18 is a diagram that shows another configuration of the control device according to one example embodiment of the present disclosure.

FIG. 19 is a diagram that shows the processing flow by the control device of another configuration of the present disclosure.

FIG. 20 is a diagram that shows another configuration of the optical repeater according to one example embodiment of the present disclosure.

FIG. 21 is a diagram that shows the processing flow by the optical repeater of another configuration of the present disclosure.

FIG. 22 is a diagram that shows another configuration of the optical repeater according to one example embodiment of the present disclosure.

FIG. 23 is a diagram that shows the processing flow by the optical repeater of another configuration of the present disclosure.

FIG. 24 is a configuration diagram that shows an overview of the computer hardware of one example embodiment of the present disclosure.

### EXAMPLE EMBODIMENT

Hereinbelow, example embodiments of the optical network system, control method, control program, control device, and optical repeater of the present disclosure will be described with reference to the drawings. In each drawing, identical elements are denoted by the same reference numerals, and duplicate explanations are omitted where necessary. Arrows added to the configuration diagrams (block diagrams) are for illustrative purposes only and do not limit the type or direction of signals.

### (Considerations Leading to Implementation)

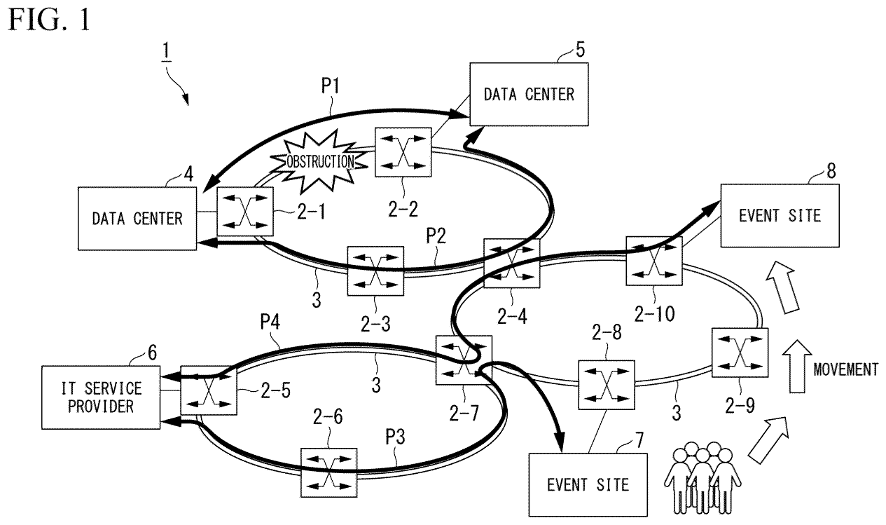

FIG. 1 shows the configuration of an optical network system according to the basic example serving as the basis of the present example embodiment. An optical network system 1 according to the basic example is, for example, a backbone wavelength-division multiplexing optical transmission system, and achieves high-capacity communication of over 100 Gbps by the devices comprising the system performing wavelength multiplexing of optical signals, as well as high-level modulation and digital coherent transmission with optical signals at different wavelengths. High-density wavelength division multiplexing enables improved optical frequency utilization efficiency, allowing the system to handle mobile traffic and wavelength defragmentation.

The optical network system 1 includes optical repeaters 2 (e.g., 2-1 to 2-10) that can flexibly switch transmission lines (wavelength paths or optical transmission lines) while maintaining the optical signals in order to accommodate switching of transmission lines in case of failure or to meet local traffic demand (e.g., traffic demand for communications from networks of data centers 4 and 5, the network of an IT service provider 6, and networks of event venues 7 and 8). The optical network system 1 can maintain communication via optical signals as infrastructure by including the optical repeaters 2 (e.g., 2-1 to 2-10). Each optical repeater 2 is a photonic node that can relay wavelength-multiplexed optical signals and is, for example, a reconfigurable optical add-drop multiplexer (ROADM) device. Each optical repeater 2 is assigned a wavelength path (also referred to simply as a path), and forwards traffic of the local network and other optical repeaters 2 accommodated via optical communication cables that pass optical signals of the assigned wavelength path to the destination network or other communication devices.

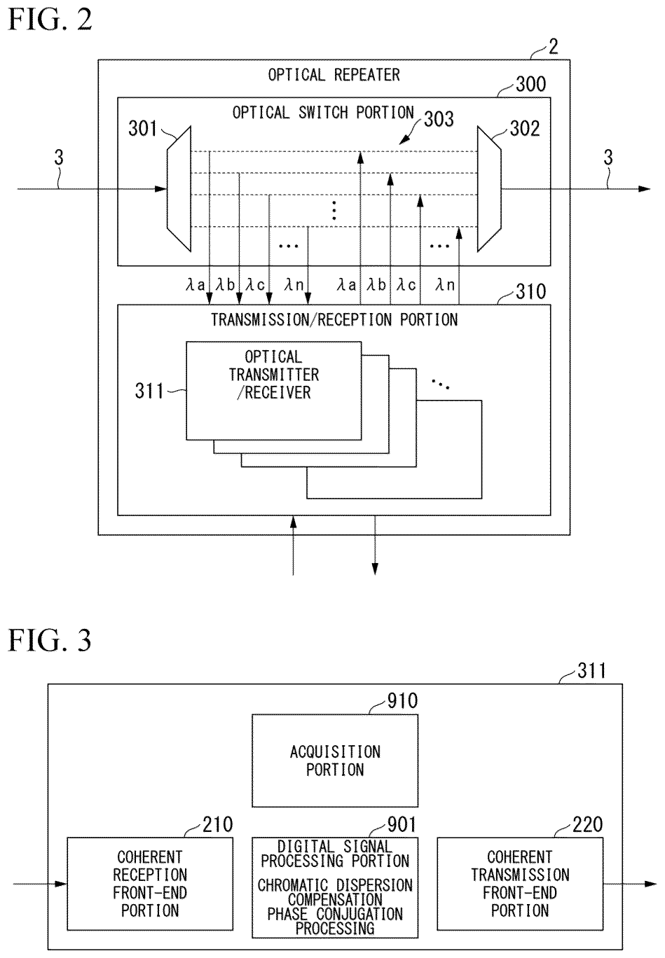

FIG. 2 shows a configuration example of the optical repeater 2 according to a basic example. The optical repeater 2 branches/inserts optical wavelength multiplex signals and coherently modulates and demodulates the signals of each wavelength subject to branching/insertion. As shown in FIG. 2, the optical repeater 2 is provided with an optical switch portion 300 and a transmission/reception portion 310.

The optical switch portion 300 forwards optical signals of a given wavelength path received from the front-stage optical repeater 2 in the optical network system 1 to the rear-stage optical repeater 2, and also branches/inserts the received optical signals by wavelength. For example, the optical switch portion 300 is provided with a demultiplexer 301, a multiplexer 302, and a branching/insertion portion 303. The demultiplexer 301 separates an optical signal received from the optical transmission line 3 into optical signals of multiple wavelengths. The multiplexer 302 combines optical signals of multiple wavelengths into a single optical signal and transmits it to the optical transmission line 3. The branching/insertion portion 303 branches/inserts optical signals of each wavelength between the demultiplexer 301 and the multiplexer 302.

The transmission/reception portion 310 (transponder) receives optical signals of each wavelength branched from the branching/insertion portion 303 of the optical switch portion 300 and outputs coherently demodulated received data to the local device (network) that accommodates it. The transmission/reception portion 310 inputs transmission data from the local device and transmits (inserts) optical signals of each wavelength that have been coherently modulated to the branching/insertion portion 303 of the optical switch portion 300. The transmission/reception portion 310 includes a plurality of optical transmitters/receivers 311 that transmit and receive optical signals at various wavelengths. Each optical transmitter/receiver 311 receives optical signals of a predetermined wavelength and further transmits optical signals of a predetermined wavelength (the same or different wavelength from the received wavelength) to the destination.

The issues that arise in a case where using an optical transmitter/receiver as the optical transmitter/receiver 311 are discussed here. FIG. 3 shows an example configuration of an optical transmitter/receiver according to this disclosure. As shown in FIG. 3, the optical transmitter/receiver 311 according to this disclosure is provided with a coherent reception front-end portion 210, a coherent transmission front-end portion 220, an acquisition portion 910, and a digital signal processing portion 901. Digital signal processing enables phase conjugation processing and chromatic dispersion compensation on a per-channel basis.

The coherent reception front-end portion 210 performs coherent detection of the optical signal received from the optical repeater 2 in the previous stage using local oscillator (LO) light of a predetermined wavelength and outputs the detected signal to the digital signal processing portion 901. The coherent transmission front-end portion 220 optically modulates the signal processed by the digital signal processing portion 901 to a predetermined wavelength (coherent modulation) and transmits the generated optical signal to the optical repeater 2 of the next stage. The digital signal processing portion 901 is a digital signal processor (DSP) that converts the signal detected coherently by the coherent reception front-end portion 210 into a digital signal, outputs the processed received data, replays the input transmission data, and outputs the signal converted for optical modulation to the coherent transmission front-end portion 220. In this disclosure, phase conjugation processing and chromatic dispersion compensation are performed on a per-channel basis in the digital signal processing portion 901.

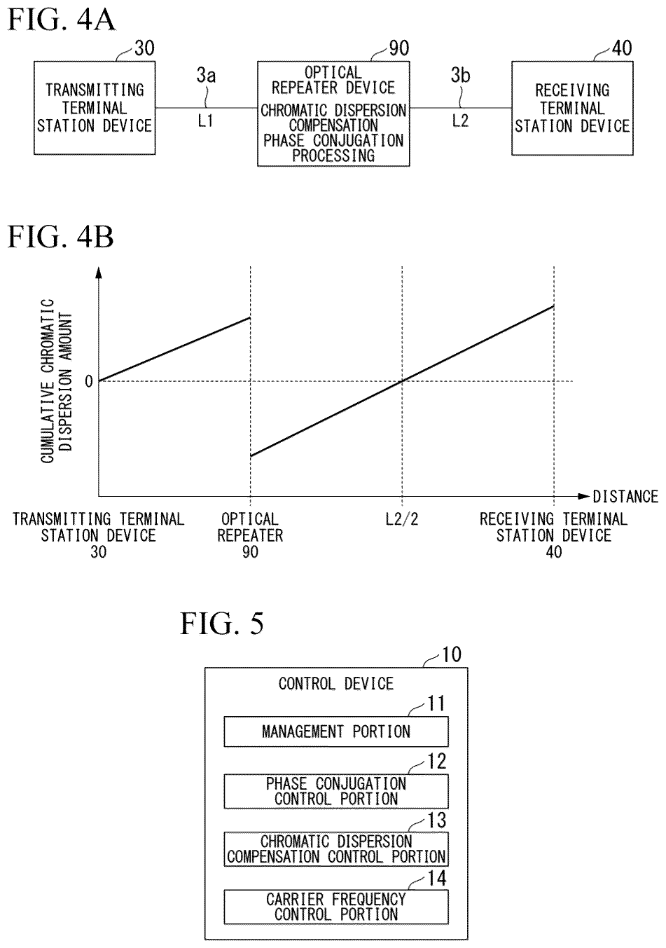

FIG. 4A and FIG. 4B show the chromatic dispersion amount in a case where using an optical repeater 90 including the optical transmitter/receiver 311 of this disclosure. As shown in FIG. 4A, the optical repeater 90 is connected between the transmitting terminal station device (transmitting end) 30 and the receiving terminal station device (receiving end) 40 via optical transmission lines 3a and 3b. The optical transmission line 3a consists of distance L1 and optical transmission line 3b consists of distance L2, and L1 and L2 may be the same length or different. Optical signals of wavelength λ1 are transmitted in the optical transmission line 3a, and optical signals of wavelength λ2 are transmitted in the optical transmission line 3b.

In a configuration in which the optical repeater 90 is connected to the path from the transmitting terminal station device 30 to the receiving terminal station device 40 as shown in FIG. 4A, the side closer to the transmitting terminal station device 30 than the optical repeater 90 may be called the first stage of the optical repeater 90 (the reception side of optical signals) while the side closer to the receiving terminal station device 40 than the optical repeater 90 may be called the second stage of the optical repeater (the transmission side of optical signals). The optical transmission line between the optical repeater 90 and the transmitting terminal station device 30 may be referred to as the front-stage (first portion) optical transmission line, and the optical transmission line between the optical repeater 90 and the receiving terminal station device 40 as the rear-stage (second portion) optical transmission line.

As shown in FIG. 4B, the chromatic dispersion amount increases in proportion to the distance of the optical transmission line. Therefore, if the optical repeater 90 relays optical signals only by mere signal amplification, the chromatic dispersion amount continues to increase with distance from the transmitting terminal station device 30 to the receiving terminal station device 40. Then, as the distance of the optical transmission line increases, the quality of the optical signal received at the receiving terminal station device 40 deteriorates significantly. In addition to chromatic dispersion, nonlinear distortion also causes significant degradation of optical signal quality. Nonlinear distortion is a phenomenon in which the phase of light itself changes due to a change in the refractive index in the material in proportion to the optical signal intensity as the optical signal propagates through the optical fiber. Such nonlinear distortion is a limiting factor for high-capacity and long-distance transmission of optical signals due to high baud rate and high multi-level transmission.

In the example disclosed above, in a case where the optical repeater 90 connected to the path from the transmitting terminal station device 30 to the receiving terminal station device 40 receives optical signals including one or more optical channels, phase conjugation processing and equivalent digital signal processing of chromatic dispersion compensation are performed for each channel received. In the example disclosed above, in the optical repeater 90, the nonlinear distortion generated in the transmission path of the front stage and the nonlinear distortion generated in the transmission path of the rear stage are canceled by performing phase conjugation processing and chromatic dispersion compensation, whereby the effect of nonlinear distortion at the receiving terminal station device 40, which is the receiving end, can be mitigated.

The example disclosed above here compensates for the effects of in-channel nonlinear distortion in optical transmission lines. Intra-channel nonlinear distortion refers to the nonlinear distortion that occurs within a single channel during single-channel transmission through the optical transmission line.

In addition to the example disclosed above, it is desirable to be able to obtain sufficient compensation effect for inter-channel nonlinear distortion in a case where there are multiple optical channels of optical transmission signals transmitted in an optical fiber. The present disclosure makes it possible to compensate for nonlinear effects between channels during multi-channel transmission in optical repeaters in multiple optical transmission networks. Nonlinear distortion can be classified into intra-channel nonlinear distortion and inter-channel nonlinear distortion. Intra-channel nonlinear distortion indicates the nonlinear distortion generated in the relevant channel by the optical signal of the channel. On the other hand, inter-channel nonlinear distortion indicates the nonlinear distortion generated within a channel due to the optical signals of channels other than the channel in question in a case where multiple optical channels are transmitted through the optical transmission line.

The following is an overview of the present example embodiment. In a case where an optical repeater receives optical signals including multiple channels, the relay configuration is shown with optical phase conjugation for compensation of inter-channel nonlinear distortion in addition to intra-channel nonlinear distortion, and optimal chromatic dispersion compensation and carrier frequency switching according to the channel frequency bandwidth. Furthermore, although the effect of compensating for intra-channel nonlinear distortion and inter-channel nonlinear distortion is smaller, either one of optimal chromatic dispersion compensation or carrier frequency switching may be used depending on the channel band.

### (Outline of Example Embodiment)

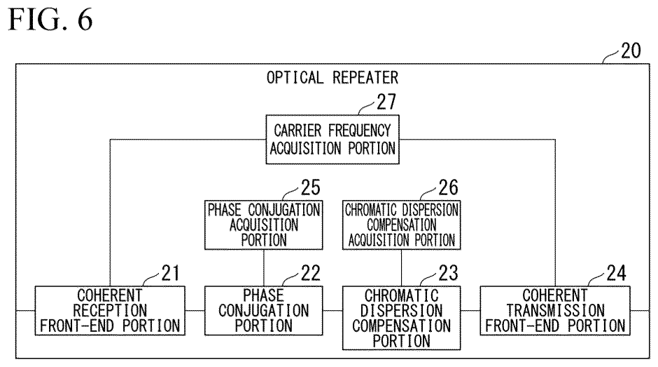

FIG. 5 shows the outline configuration of the control device according to the present example embodiment. FIG. 6 shows the outline configuration of the optical relay system according to the present example embodiment. A control device 10 and an optical repeater 20 constitute an optical network system. The optical repeater 20 according to the present example embodiment constitutes a part of the optical network system, and the control device 10 according to the present example embodiment controls the optical repeater 20, which is another component of the optical network system.

As shown in FIG. 5, the control device 10 includes a management portion 11, a phase conjugation control portion 12, a chromatic dispersion compensation control portion 13, and a carrier frequency control portion 14. The management portion 11 manages transmission line information of optical transmission lines connected to the optical repeater 20 in an optical network path. The phase conjugation control portion 12 determines the phase conjugation process in the optical repeater 20 based on the transmission line information managed by the management portion 11 and the wavelength information managed by the carrier frequency control portion 14. The chromatic dispersion compensation control portion 13 determines the chromatic dispersion compensation amount to be applied in the optical repeater 20 based on the transmission line information managed by the management portion 11 and the carrier frequency managed by the carrier frequency control portion. The carrier frequency control portion 14 specifies the order of magnitude of frequency values in the frequency domain for each channel of an optical signal including multiple channels received by the optical repeater 20, and controls the carrier frequency of the transmitted signal of each channel so that the order of magnitude of frequency values in the frequency domain is switched for each channel in the frequency domain in the transmitted signal.

As shown in FIG. 6, the optical repeater 20 includes a coherent reception front-end portion 21, a phase conjugation portion 22, a chromatic dispersion compensation portion 23, a coherent transmission front-end portion 24, a phase conjugation acquisition portion 25, a chromatic dispersion compensation acquisition portion 26, and a carrier frequency acquisition portion 27. Although not shown in FIG. 6, multiple optical channels are transmitted and received, and phase conjugation, chromatic dispersion compensation, and carrier frequency setting are performed for each channel signal.

The phase conjugation acquisition portion 25 acquires the phase conjugation process determined by the phase conjugation control portion 12 from the control device 10. The chromatic dispersion compensation acquisition portion 26 acquires the chromatic dispersion compensation amount determined by the chromatic dispersion compensation control portion 13 from the control device 10. The carrier frequency acquisition portion 27 acquires information on the reception carrier frequency and transmission carrier frequency of each channel as determined by the carrier frequency control portion 14. The coherent reception front-end portion 21 performs coherent detection of the received optical signal based on the local oscillator light of the reception carrier frequency obtained from the carrier frequency acquisition portion 27 and outputs a coherently detected electrical signal. The phase conjugation portion 22 performs phase conjugation processing by digital signal processing on the electrical signal output from the coherent reception front-end portion 21 based on the phase conjugation processing settings acquired by the phase conjugation acquisition portion 25. The chromatic dispersion compensation portion 23 performs chromatic dispersion compensation processing by digital signal processing on the electrical signal output from the phase conjugation portion 22 based on the chromatic dispersion compensation amount acquired by the chromatic dispersion compensation acquisition portion 26. The coherent transmission front-end portion 24 performs coherent modulation on the electrical signal subject to phase conjugation processing by the phase conjugation portion 22 and the electrical signal subject to chromatic dispersion compensation processing by the chromatic dispersion compensation portion 23 based on the local oscillator light of the transmission carrier frequency acquired from the carrier frequency acquisition portion 27, and transmits the coherently modulated optical signal.

Thus, in the present example embodiment, the control device 10 determines the phase conjugation processing and the chromatic dispersion compensation amount in the optical repeater 20 based on the wavelength information and the signal bandwidth information of optical signals transmitted and received by the optical repeater 20 in the path, and the transmission line information of the optical transmission line connected to the optical repeater 20. The control device 10 performs the determined phase conjugation processing and chromatic dispersion compensation of the chromatic dispersion compensation amount for compensation of nonlinear distortion in the optical repeater 20. The control device 10 specifies the order of magnitude of frequency values in the frequency domain for each channel of an optical signal including multiple channels received by the optical repeater 20, and compensates for inter-channel nonlinear effects by controlling the carrier frequency so that the order of magnitude of frequency values in the frequency domain is switched for each channel in the frequency domain in the transmitted signal.

By performing phase conjugation of optical signals with the optical repeater 20, it is possible to invert the distortion of the optical signal in the front-stage optical transmission line of the optical repeater 20. As the signal propagates through the rear-stage optical transmission path of the optical repeater 20, the distortion is reproduced in reverse and so the distortion is canceled at the receiving end. Since the example embodiment described below enables chromatic dispersion compensation with appropriate phase conjugation and a chromatic dispersion compensation amount in the optical repeater 20, using the phase conjugation and chromatic dispersion compensation at each optical repeater 20 in a multi-span optical network, it is possible to maximize the cancellation effect of nonlinear distortion caused by multi-span optical transmission, enabling the effective suppression of degradation of signal quality due to nonlinear distortion at the receiving end of the optical network. Additionally, by selecting the optimal chromatic dispersion compensation according to the carrier frequency and signal bandwidth, and the carrier frequency so as to switch the order of magnitude of frequency values in the frequency domain for each channel in a multi-channel optical signal in the optical repeater 20, it is also possible to suppress inter-channel nonlinear effects.

### Example Embodiment 1

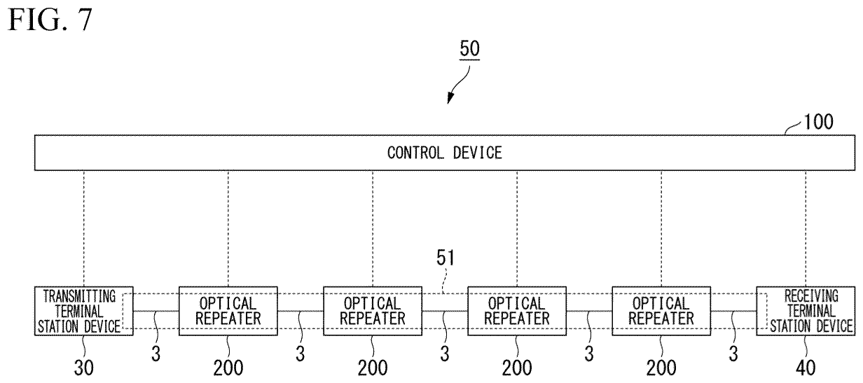

Next, Example embodiment 1 shall be explained with reference to the drawings. FIG. 7 shows a configuration example of an optical network system in accordance with one example embodiment of the present disclosure. As shown in FIG. 7, an optical network system 50 in accordance with one example embodiment of the present disclosure includes a control device 100, a plurality of optical repeaters 200, the transmitting terminal station device 30, and the receiving terminal station device 40.

The plurality of the optical repeaters 200, the transmitting terminal station device 30, and the receiving terminal station device 40 are connected to each other via optical transmission lines 3 to enable optical communication. The plurality of the optical repeaters 200, the transmitting terminal station device 30, the receiving terminal station device 40, and the control device 100 are connected to enable communication of control signals. The plurality of the optical repeaters 200, the transmitting terminal station device 30, the receiving terminal station device 40 and the control device 100 may be connected via the optical transmission lines 3 or may be communicatively connected by any other transmission line, including wired or wireless.

The plurality of the optical repeaters 200, the transmitting terminal station device 30, and the receiving terminal station device 40 are optical transmission devices (optical nodes) that perform optical communications via the optical transmission lines 3. The transmitting terminal station device 30 constitutes the transmitting end in a path configured by the connection of multiple optical transmission paths 3. The receiving terminal station device 40 constitutes the receiving end in a path configured by the connection of multiple optical transmission lines 3. The transmitting terminal station device 30 transmits multi-channel optical signals wavelength-multiplexed by the wavelength of the path set by the control device 100 to the receiving terminal station device 40 via the optical transmission lines 3. The receiving terminal station device 40 receives the multi-channel optical signals wavelength-multiplexed by the wavelength of the path set by the control device 100 from the transmitting terminal station device 30 via the optical transmission lines 3.

The plurality of optical repeaters 200 are repeaters that can relay wavelength-multiplexed multi-channel optical signals, as in the basic example. The plurality of optical repeaters 200 constitute an optical network 51 that performs WDM communications. The plurality of the optical repeaters 200, together with the transmitting terminal station device 30 and the receiving terminal station device 40, can be said to constitute the optical network 51. The optical network 51 is a wavelength-division multiplexed optical network, as in FIG. 1. The optical network 51 can be a mesh-shaped network, ring-shaped network, point-to-point, or other topology. The plurality of the optical repeaters 200 configure a path from the transmitting terminal station device 30 to the receiving terminal station device 40 in accordance with the control from the control device 100, and transmit optical signals (data) according to wavelengths set on the route of the path.

The control device 100 manages and controls the optical network 51 including the plurality of the optical repeaters 200. For example, the control device 100 is a Network Management System (NMS) that manages the network.

The control device 100 manages and controls the paths configured by the optical repeater 200 in the optical network 51. The control device 100 manages the path route and wavelengths from the transmitting terminal station device 30 to the receiving terminal station device 40, and sets the path route and wavelengths etc. for the transmitting terminal station device 30, the receiving terminal station device 40 and the optical repeaters 200 on the path route.

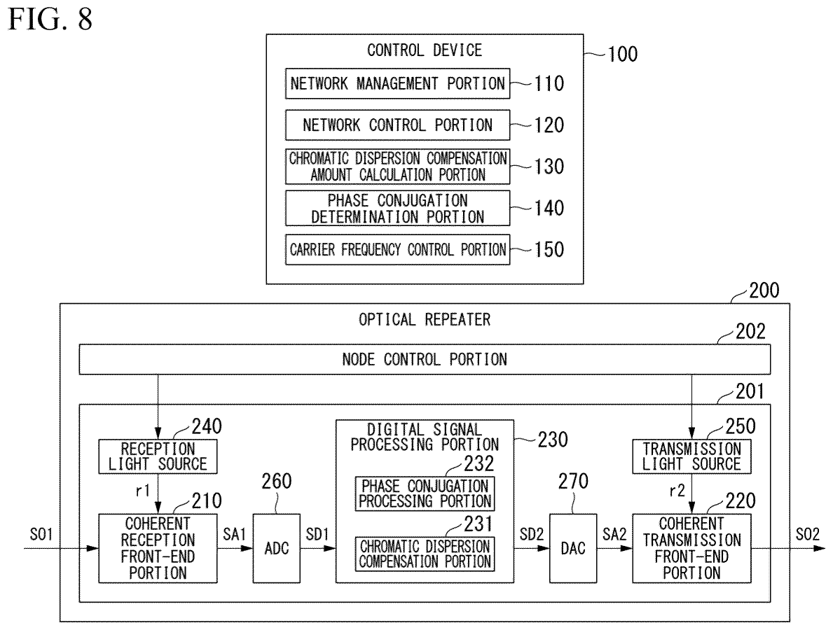

FIG. 8 shows a configuration example of each device in an optical network system according to one example embodiment of the present disclosure. As shown in FIG. 8, the control device 100 includes a network management portion 110, a network control portion 120, a chromatic dispersion compensation amount calculation portion 130, a phase conjugation determination portion 140, and a carrier frequency control portion 150.

The network management portion 110 corresponds to the management portion 11 shown in FIG. 5 and manages information necessary for network management, such as network configuration information and path configuration information in the optical network 51. For example, the network management portion 110 may include a database that stores information necessary for network management. The network configuration information includes the connection relationship among the optical repeaters 200, transmitting terminal station device 30, and receiving terminal station device 40 that comprise the network, as well as transmission line information for the optical transmission lines 3 that connect the devices. Transmission line information includes the distance L (transmission path length) of the optical transmission line and may include the structure and type of optical fibers, transmission characteristics, and the like. The path configuration information includes information on each device comprising the path, the wavelengths available to each device on the route of the path, and the usage status of the wavelengths. These pieces of information may be set in a database in advance, or may be set by information collected from each device, and may also be updated by the network control portion 120 and the like.

The network control portion 120 corresponds to the management portion 11 shown in FIG. 5, and controls the paths in the optical network 51 and the optical repeaters 200, the transmitting terminal station device 30, and the receiving terminal station device 40 that comprise the paths. The network control portion 120 refers to the network configuration information, path configuration information, and the like in the network management portion 110, determines the route of the paths from the transmitting terminal station device 30 to the receiving terminal station device 40, and sets the determined route to the transmitting terminal station device 30, receiving terminal station device 40, and optical repeaters 200 on the route of the paths. The network control portion 120 outputs the information necessary to calculate the chromatic dispersion compensation amount in the optical repeaters 200 that constitute the path to the chromatic dispersion compensation amount calculation portion 130. For example, the network control portion 120 outputs transmission line information for the front and rear optical transmission lines. The network control portion 120 outputs the phase conjugation determination information in the optical repeater 200 that constitutes the path to the phase conjugation determination portion 140. For example, the network control portion 120 outputs the number of paths and the number of optical repeaters in the optical network 51.

The chromatic dispersion compensation amount calculation portion 130 calculates the chromatic dispersion compensation amount for the optical repeaters 200 comprising the path to perform chromatic dispersion compensation, corresponding to the chromatic dispersion compensation control portion 13 shown in FIG. 5. The chromatic dispersion compensation amount calculation portion 130 is a compensation control portion that determines and controls the chromatic dispersion compensation amount of each optical repeater 200. The chromatic dispersion compensation amount calculation portion 130 determines the optimal chromatic dispersion compensation amount for the optical repeater 200 based on the reception wavelength information, signal bandwidth, transmission wavelength information, and transmission line information before and after the optical repeater 200 acquired from the network control portion 120 and the carrier frequency control portion 150. The chromatic dispersion compensation amount calculation portion 130 notifies the relevant optical repeater 200 of the reception wavelength information, transmission wavelength information, and optimal chromatic dispersion compensation amount of the optical repeater 200.

The phase conjugation determination portion 140 controls the phase conjugation processing of the optical repeaters 200 that comprise the path, corresponding to the phase conjugation control portion 12 shown in FIG. 5. The phase conjugation determination portion 140 determines the optimal phase conjugation processing for each optical repeater 200 based on the number of paths and the number of optical repeaters in the optical network 51 acquired from the network control portion 120. The phase conjugation determination portion 140 notifies the optical repeater 200 of the phase conjugation processing information.

The carrier frequency control portion 150, which corresponds to the carrier frequency control portion 14 shown in FIG. 5, determines the carrier frequency of each channel of an optical signal in the path from the transmitting terminal station device 30 to the receiving terminal station device 40, and sets the determined carrier frequency to the transmitting terminal station device 30, the receiving terminal station device 40 and optical repeaters 2 on the route of the path. The carrier frequency of the light in a path is determined for each optical transmission path in the route of the path. The carrier frequency control portion 150 outputs the information necessary to calculate the chromatic dispersion compensation amount in the optical repeaters 200 that constitute the path to the chromatic dispersion compensation amount calculation portion 130. For example, the carrier frequency control portion 150 outputs the reception wavelength information (wavelength information of received optical signals) and transmission wavelength information (wavelength information of transmitted optical signals) of the optical repeater 200.

Suppose that optical repeater 200 receives an optical signal including multiple channels. The carrier frequency selection portion 150 specifies, among the plurality of channels of different frequency bands of the optical signal received by the relevant optical repeater 200, the order of magnitude of the frequency values of each channel of the plurality of channels ordered based on the frequency band, and determines the carrier frequency of each channel in the received signal so that the order is reversed in the transmission signal, and the carrier frequency of each channel in the transmission signal based on the signal bandwidth. The carrier frequency selection portion 150 notifies the relevant optical repeater 200 of the determined carrier frequency for each channel of the received signal and transmitted signal of the optical repeater 200.

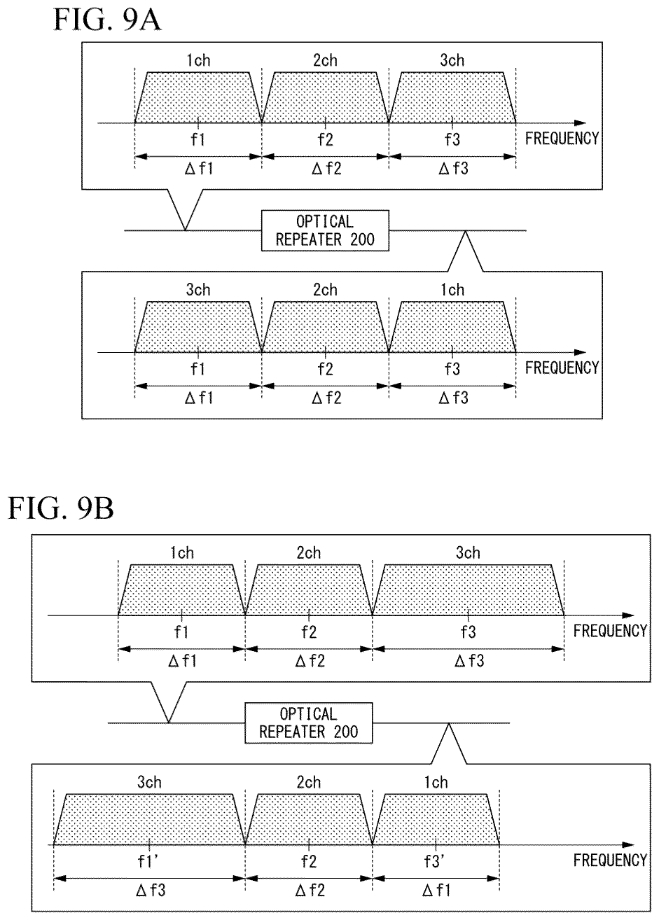

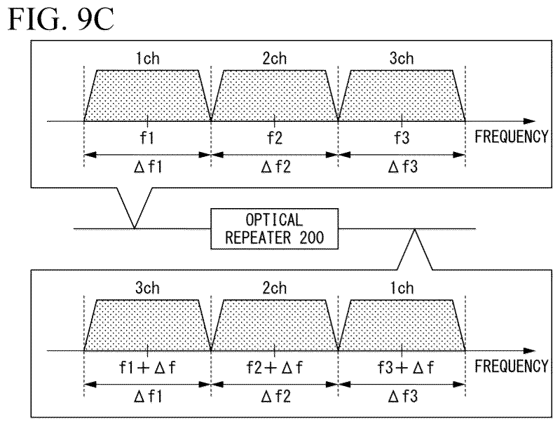

FIG. 9A is the first diagram showing an overview of the carrier frequency settings for performing channel switching as directed by the carrier frequency selection portion 150. The optical repeater 200 is assumed to receive signals in the frequency bands of the first channel 1ch, the second channel 2ch, and the third channel 3ch. The carrier frequencies of each channel are f1, f2, and f3, respectively, and the respective signal bands of the channels are Δf1, Δf2, and Δf3. The carrier frequency control portion 150 sets the carrier frequency of each channel so as to produce an output signal in which the order of magnitude of the frequency values in the frequency domain of the channel received by the optical repeater 200 is reversed. In a case where the signal bandwidths of the channels are all equal, the order of the magnitude of the frequency values of the channels is reversed by setting the carrier frequency of the first channel to f3, the carrier frequency of the second channel to f2, and the carrier frequency of the third channel to f1.

FIG. 9B is the second diagram showing an overview of the carrier frequency settings for performing channel switching as directed by the carrier frequency selection portion 150. The optical repeater 200 is assumed to receive signals in the frequency bands of the first channel 1ch, the second channel 2ch, and the third channel 3ch. The carrier frequencies of each channel are f1, f2, and f3, respectively, and the signal bands are Δf1, Δf2, and Δf3, respectively. Assume that the signal bandwidths indicated by Δf1, Δf2, and Δf3 are not equivalent, respectively. The carrier frequency control portion 150 sets the carrier frequency of each channel so as to produce an output signal in which the order of magnitude of the frequency values in the frequency domain of the channel received by the optical repeater 200 is reversed. The carrier frequencies of each of the first, second, and third channels of the output signal of the optical repeater 200 are f3′ (=f2+(f2−f1)), f2, f1′ (=f2−(f3−f2)), so that the order of magnitude of frequency values of each channel is in reverse order. The optical repeater 200 outputs optical signals with the signal bandwidth of each channel set the same for reception and transmission by the optical repeater 200. In other words, the signal bandwidths during transmission by the optical repeaters 200 of channels 1ch, 2ch, and 3ch are the same Δf1, Δf2, and Δf3 as the signal bandwidths during reception, respectively.

FIG. 9C is a third diagram showing an overview of carrier frequency settings for channel switching as directed by the carrier frequency selection portion 150. Each optical repeater 200 is assumed to receive signals in the frequency bands of the first channel 1ch, the second channel 2ch, and the third channel 3ch. The carrier frequencies of each channel are f1, f2, and f3, respectively, and the signal bands are Δf1, Δf2, and Δf3, respectively. The carrier frequency control portion 150 sets the carrier frequency of each channel so as to produce an output signal in which the order of the magnitude of the frequency values in the frequency domain of each channel received by the optical repeater 200 is reversed, and furthermore, each channel is given a uniform frequency offset Δf. By setting the carrier frequencies of the first, second, and third channels of the output signal of the optical repeater 200 as f3+Δf, f2+Δf, and f1+Δf, the order of the magnitude of the frequency values of each channel is reversed, and an optical signal with uniform frequency offset is also transmitted. This allows the optical repeater 200 to transmit to the path a transmission signal having a bandwidth different from the bandwidth of the optical signal received by the optical repeater 200. It can be applied to wavelength conversion repeater systems that convert the wavelengths of received and transmitted signals in the optical repeater.

In the optical network 51, multi-channel optical signals are relayed by multiple optical repeaters 200 through optical transmission lines 3. In a case where the multiple optical repeaters 200 in the optical network 51 change the channel order for the channels of an optical signal, the carrier frequency at the receiving end of the channels is notified to the receiving terminal station device 40.

As shown in FIG. 8, the optical repeater 200 according to one example embodiment of the present disclosure includes an optical transmitter/receiver 201 and a node control portion 202. Although the illustration is omitted in FIG. 8, in order to perform transmission and reception of multiple optical channels, the optical repeater 200 includes the optical switch portion 300 and the transmission/reception portion 310, as in the basic example in FIG. 2, and includes a plurality of the optical transmitters/receivers 201 in the transmission/reception portion 310. In other words, the node control portion 202 can control the optical switch portion 300 and the transmission/reception portion 310 (the multiple optical transmitters/receivers 201 (equivalent to the optical transmitter/receiver 311 in FIG. 3)).

Each optical transmitter/receiver 201 is provided with the coherent reception front-end portion 210, the coherent transmission front-end portion 220, a digital signal processing portion 230, a reception light source 240, a transmission light source 250, an analog to digital converter (ADC) 260, and a digital to analog converter (DAC) 270.

The reception light source 240 generates local oscillator light r1 of the wavelength (frequency) set by the node control portion 202 and outputs the generated local oscillator light r1 to the coherent reception front-end portion 210. The transmission light source 250 generates the transmission light r2 of the wavelength (frequency) set by node control portion 202 and outputs the generated transmission light r2 to the coherent transmission front-end portion 220.

The frequency (wavelength) of the local oscillator light r1 is the frequency (carrier frequency) of the input optical signal SO1 that is received, and the frequency of the transmission light r2 is the frequency of the output optical signal SO2 that is transmitted. The carrier frequencies of local oscillator light r1 and r2 are determined based on the carrier frequency information obtained by the node control portion 202 from the carrier frequency control portion 150.

The coherent reception front-end portion 210 and the coherent transmission front-end portion 220 have the same configuration as in FIG. 3. The coherent reception front-end portion 210 is an optical/electrical converter that converts optical signals to electrical signals and is a coherent detection portion that performs coherent detection. The coherent reception front-end portion 210 performs coherent detection of the input optical signal SO1 (received optical signal) that is input based on the local oscillator light r1, and outputs the generated analog signal SA1 (first analog electrical signal).

The ADC 260 performs analog/digital conversion of the analog signal SA1 generated by the coherent reception front-end portion 210 and outputs the converted digital signal SD1 (first digital electrical signal).

The DAC 270 performs digital/analog conversion of the digital signal SD2 (second digital electrical signal) processed by the digital signal processing portion 230 and outputs the converted analog signal SA2 (second analog electrical signal).

The coherent transmission front-end portion 220 is an electrical/optical converter that converts electrical signals to optical signals and a coherent modulation portion that performs coherent modulation. The coherent transmission front-end portion 220 coherently modulates the analog signal SA2, which has been DA-converted by the DAC 270, based on the transmission light r2, and outputs the generated output optical signal SO2 (transmitted optical signal).

For example, the input optical signal SO1 and the output optical signal SO2 are phase modulated and polarization multiplexed optical signals. The analog signals SA1 and SA2 and digital signals SD1 and SD2 are four-lane (4-channel) signals that include the IX signal of the I component (in-phase component) of X polarization, the QX signal of the Q component (quadrature component) of X polarization, the IY signal of the I component of Y polarization, and the QY signal of the Q component of Y polarization.

The digital signal processing portion 230 performs digital signal processing on the digital signal SD1 converted by the ADC 260 and outputs the digital signal SD2 after digital signal processing. The digital signal processing portion 230 is a digital circuit that performs the prescribed digital signal processing to compensate for signal quality. The digital signal processing portion 230 performs digital signal processing on all or some of the four-lane IX, QX, IY, and QY signals (X or Y polarization), respectively.

The digital signal processing portion 230 performs specific signal processing without performing processing that involves significant delays, such as code error correction (data regeneration). This allows the required signal quality to be compensated while minimizing signal delay. In the present example embodiment, the digital signal processing portion 230 has a chromatic dispersion compensation portion 231 (equivalent to the chromatic dispersion compensation portion 23 in FIG. 6) that performs chromatic dispersion processing and a phase conjugation processing portion 232 (equivalent to the phase conjugation portion 22 in FIG. 6) that performs phase conjugation processing.

The chromatic dispersion compensation through digital signal processing can be realized by convolution of the impulse response of the inverse transfer function of an optical transmission line with the received signal. Thus, for example, the chromatic dispersion compensation portion 231 may be configured with a transversal filter (FIR filter). Since the characteristics of optical transmission lines can be modeled by an FIR filter, chromatic dispersion can be compensated by an FIR filter with inverse characteristics. The FIR filter performs TDE (Time Domain Equalizing), which equalizes the received signal in the time-delay domain, while FDE (Frequency Domain Equalization), which equalizes the received signal in the frequency domain, may achieve the same characteristics. By configuring the chromatic dispersion compensation portion with FDE, the circuit scale can be reduced compared to that of an FIR filter.

In addition to transmission line chromatic dispersion compensation, the chromatic dispersion compensation portion 231 may also compensate for bandwidth degradation caused by characteristic degradation and characteristic variation of analog electrical circuits in each of the four lanes of IX, QX, IY, and QY signals, amplitude variation in the four lanes, and skew and cross-talk in the four lanes.

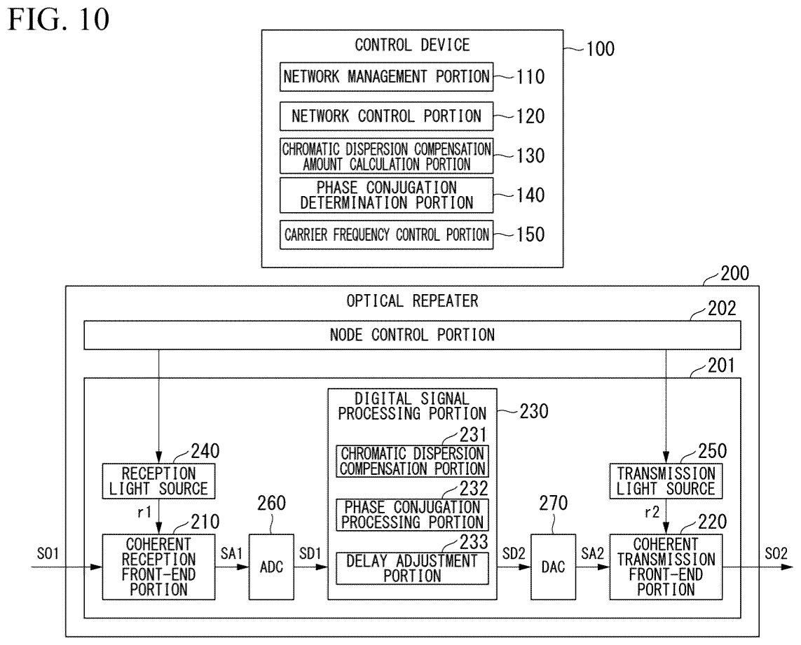

FIG. 10 shows another configuration example of each device in an optical network system according to one example embodiment of the present disclosure. As shown in FIG. 10, the delay adjustment portion 233 of the digital signal processing portion 230 of the optical repeater 200 may provide a delay that compensates for variations in optical path length inside the optical repeater and timing deviations caused by ADC, DCA and digital signal processing in a case where multiple optical signals are transmitted and received.

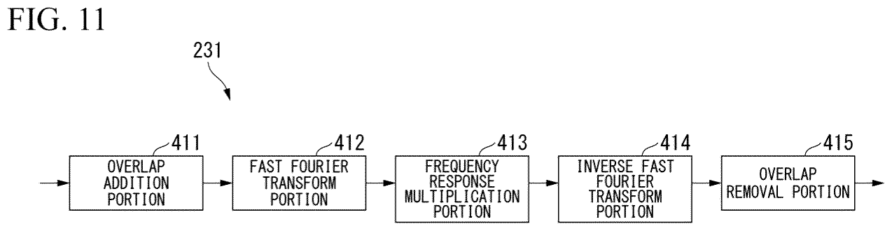

FIG. 11 is a configuration example in a case where the chromatic dispersion compensation portion 231 is configured by FDE processing. The chromatic dispersion compensation portion 231 in FIG. 11 is an example of an overlap FDE configuration and includes an overlap addition portion 411, a fast Fourier transform portion 412, a frequency response multiplication portion 413, an inverse fast Fourier transform portion 414, and an overlap removal portion 415.

The node control portion 202 sets the chromatic dispersion compensation amount notified by the control device 100 to the chromatic dispersion compensation portion 231 in the digital signal processing portion 230. In a case where the chromatic dispersion compensation portion 231 is configured with an FDE as shown in FIG. 9, the node control portion 202 sets the coefficient of the frequency response multiplication portion 413 in FIG. 9 according to the chromatic dispersion compensation amount notified by the control device 100 and the carrier frequency and signal bandwidth of each channel.

The overlap addition portion 411 causes a portion of the front and rear signals to overlap the input signal (digital signal). The fast Fourier transform portion 412 then performs a fast Fourier transform (FFT) of the overlapped signal to convert the signal into a frequency domain signal.

The frequency response multiplication portion 413 multiplies and equalizes the frequency response of the chromatic dispersion of the transmission line according to the chromatic dispersion compensation amount notified by the control device 100 and the carrier frequency and signal band of each channel.

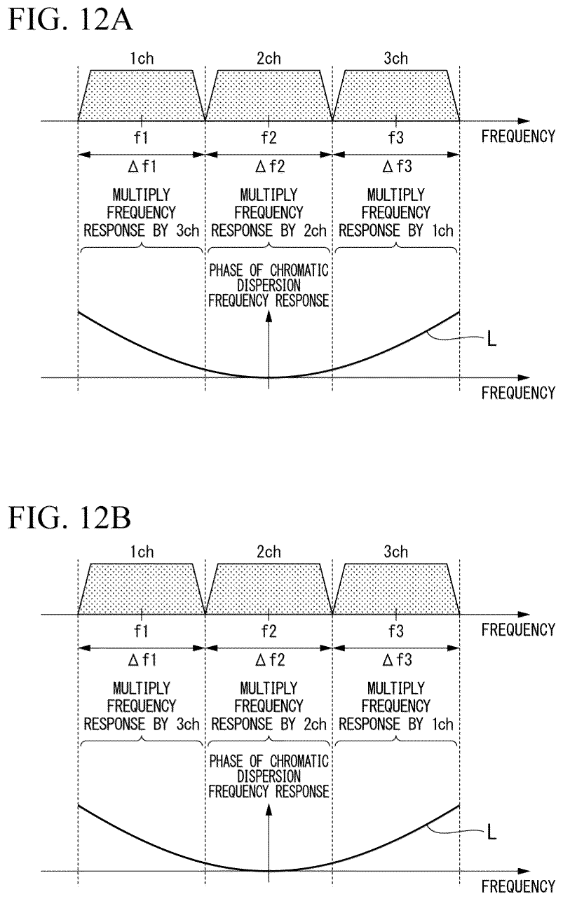

FIG. 12A is a first diagram showing an overview of determining the frequency response coefficient of the transmission line chromatic dispersion used in the frequency response multiplication portion 413, which is equalized according to the notified chromatic dispersion compensation amount and the carrier frequency and signal bandwidth of each channel. Suppose that the optical repeater 200 receives optical signals of the first channel 1ch, the second channel 2ch, and the third channel 3ch. The carrier frequencies for each channel are f1, f2, and f3, and the respective frequency bands are Δf1, Δf2, and Δf3. Curve L at the bottom of FIG. 12A shows the phase of the chromatic dispersion frequency response. The frequency response multiplication portion 413 multiplies the frequency response coefficient converted from the phase component to the complex component by the signal input from the fast Fourier transform portion 412. A complex number coefficient such as that used for the frequency application coefficient can be obtained by computing exp(iθ) from the phase component θ as indicated by the curve L at the bottom of FIG. 12A. Phase conjugation processing is performed first in the digital signal processing portion 230, followed by chromatic dispersion compensation processing. Based on the frequency inversion due to phase conjugation and the chromatic dispersion frequency response of the entire received signal bandwidth (Δf1+Δf2+Δf3), the frequency response multiplication portion 413 of each channel of the optical repeater 200 multiplies the signal of each channel input from the fast Fourier transform portion 412 by the chromatic dispersion frequency response of each frequency band of each corresponding channel.

More specifically, the frequency response multiplication portion 413 specifies the coefficient in the region of Δf3 out of the chromatic dispersion frequency response of the entire bandwidth (Δf1+Δf2+Δf3) of the received signal as the frequency application coefficient for chromatic dispersion compensation to channel 1ch, and multiplies that coefficient by the signal input from the fast Fourier transform portion 412 corresponding to channel 1ch. The frequency response multiplication portion 413 specifies the coefficient in the region of Δf2 out of the chromatic dispersion frequency response of the entire bandwidth (Δf1+Δf2+Δf3) of the received signal as the frequency application coefficient for chromatic dispersion compensation to channel 2ch, and multiplies that coefficient by the signal input from the fast Fourier transform portion 412 corresponding to channel 2ch. The frequency response multiplier 413 specifies the coefficient in the region of Δf1 out of the chromatic dispersion frequency response of the entire bandwidth (Δf1+Δf2+Δf3) of the received signal as the frequency application coefficient for chromatic dispersion compensation to channel 3ch, and multiplies that coefficient by the signal input from the fast Fourier transform portion 412 corresponding to channel 3ch. This takes into account frequency component inversion due to the phase conjugation process.

FIG. 12B is a second diagram showing an overview of determining the frequency response coefficient of the transmission line chromatic dispersion used in the frequency response multiplication portion 413, which is equalized according to the notified chromatic dispersion compensation amount and the carrier frequency and signal bandwidth of each channel. Suppose that the optical repeater 200 receives optical signals of the first channel 1ch, the second channel 2ch, and the third channel 3ch. The carrier frequencies for each channel are f1, f2, and f3, and the respective frequency bands are Δf1, Δf2, and Δf3. The curve L at the bottom of FIG. 12b shows the phase of the chromatic dispersion frequency response, and the frequency response multiplication portion 413 multiplies the frequency response coefficient converted from the phase component to the complex component by the signal input from the fast Fourier transform portion 412. Chromatic dispersion compensation processing is performed first in the digital signal processing portion 230, followed by phase conjugation processing.

Based on the chromatic dispersion frequency response of the entire received signal bandwidth (Δf1+Δf2+Δf3), the frequency response multiplication portion 413 of each channel of the optical repeater 200 multiplies the signal of each channel input from the fast Fourier transform portion 412 by the chromatic dispersion frequency response of each frequency band of each corresponding channel. More specifically, the frequency response multiplication portion 413 specifies the coefficient in the region of Δf1 out of the chromatic dispersion frequency response of the entire bandwidth (Δf1+Δf2+Δf3) of the received signal as the frequency application coefficient for chromatic dispersion compensation to channel 1ch, and multiplies that coefficient by the signal input from the fast Fourier transform portion 412 corresponding to channel 1ch. The frequency response multiplication portion 413 specifies the coefficient in the region of Δf2 out of the chromatic dispersion frequency response of the entire bandwidth (Δf1+Δf2+Δf3) of the received signal as the frequency application coefficient for chromatic dispersion compensation to channel 2ch, and multiplies that coefficient by the signal input from the fast Fourier transform portion 412 corresponding to channel 2ch. The frequency response multiplier 413 specifies the coefficient in the region of Δf3 out of the chromatic dispersion frequency response of the entire bandwidth (Δf1+Δf2+Δf3) of the received signal as the frequency application coefficient for chromatic dispersion compensation to channel 3ch, and multiplies that coefficient by the signal input from the fast Fourier transform portion 412 corresponding to channel 3ch.

This enables the optical repeater 200 to also compensate for differences in group delay characteristics between channels in a case where receiving multi-channel signals, and to compensate for inter-channel nonlinear distortion due to phase conjugation.

The inverse fast Fourier transform portion 414 then performs the inverse fast Fourier transform (IFFT) to convert the signal into a time-domain signal. The overlap removal portion 415 removes the overlapping portion from the restored signal in the time domain and outputs it. In a case where using FDE, the chromatic dispersion compensation amount can be adjusted by changing the inverse transfer function. The overlap addition portion 411 and overlap removal portion 415 may be omitted.

Phase conjugation processing by digital signal processing determines the complex conjugate of the input digital signal. That is, the sign of the imaginary component Q in the Ix, Qx, Iy, and Qy signals is inverted as in the following Expression (1).

$$\begin{matrix}{I}_{X} = Re [ ( {I}_{X} - j {Q}_{x} ) {e}^{j ∅1} ] \\ {Q}_{X} = I m [ ( {I}_{X} - {jQ}_{x} ) {e}^{j ∅ 1} ] \\ {I}_{Y} = Re [ ( {I}_{Y} - j {Q}_{Y} ) {e}^{j ∅ 2} ] \\ {Q}_{Y} = I m [ ( {I}_{Y} - j {Q}_{Y} ) {e}^{j ∅ 2} ]\end{matrix} \} \qquad ( 1 )$$

The node control portion 202 receives control information from the control device 100 and controls each part of the optical repeater 200 based on the received control information. The node control portion 202 is an acquisition portion that acquires the optimal chromatic dispersion compensation amount according to each channel's frequency band from the chromatic dispersion compensation amount calculation portion 130, phase conjugation processing information from the phase conjugation determination portion 140, and reception wavelength information and transmission wavelength information from the carrier frequency control portion 150. The node control portion 202 sets the frequency (wavelength) of the local oscillator light r1 to the reception light source 240 based on the acquired reception wavelength information and sets the frequency of the transmission light r2 to the transmission light source 250 based on the acquired transmission wavelength information. The node control portion 202 sets the phase conjugation processing operation to the phase conjugation processing portion 232 based on control information including instructions to perform phase conjugation processing acquired from the control device 100. The node control portion 202 sets the chromatic dispersion compensation amount to the chromatic dispersion compensation portion 231 based on the optimal chromatic dispersion compensation amount that was acquired.

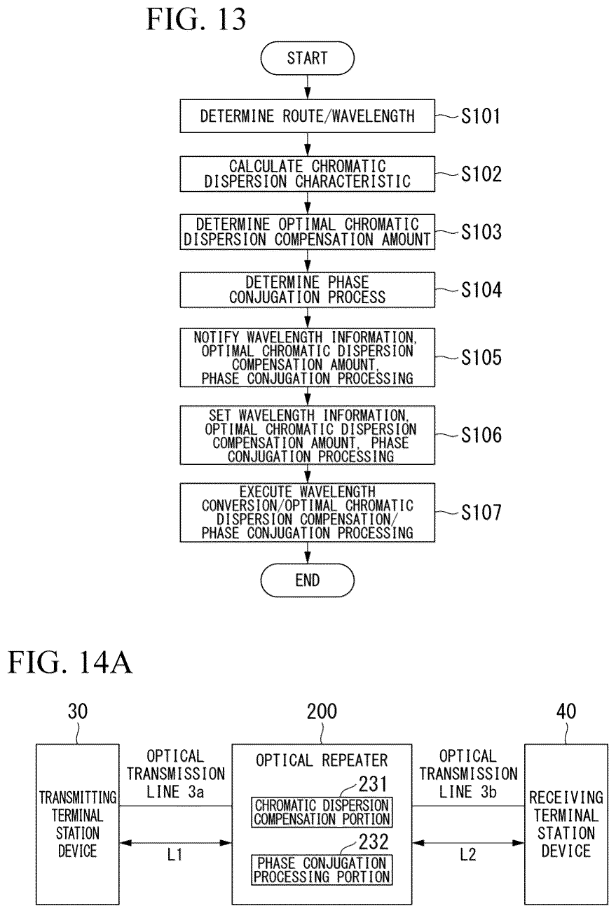

FIG. 13 shows an example of the operation of the optical network system according to the example embodiment of the present disclosure. As shown in FIG. 13, first, the network management portion 110 of the control device 100 determines the optical transmission line information of the front-stage and rear-stage optical transmission lines of the optical repeater 200. The carrier frequency control portion 150 determines the wavelength to be used by the optical repeater 200 (S101). The network control portion 120 of the control device 100 determines the path route in the optical network 51 and identifies the optical transmission line and the optical repeaters 200 on the path route. By determining the wavelength of each optical transmission line that is identified, the carrier frequency control portion 150 determines the wavelengths of the front stage and rear stage (before and after conversion) in each optical repeater 200, i.e., the wavelengths of the optical signals transmitted and received by the optical repeater 200. The network control portion 120 and the carrier frequency control portion 150 output the reception wavelength information and transmission wavelength information of the optical repeater 200 according to the determined wavelengths to the chromatic dispersion compensation amount calculation portion 130, the phase conjugation determination portion 140, and the carrier frequency control portion 150, and also output the transmission line information (distance) of the front-stage and rear-stage optical transmission line of the optical repeater 200 to the chromatic dispersion compensation amount calculation portion 130 and the phase conjugation determination portion 140. If the path includes multiple optical repeaters 200, the following process is performed for each optical repeater.

Next, the chromatic dispersion compensation amount calculation portion 130 of the control device 100 calculates the chromatic dispersion characteristics in the front-stage and rear-stage optical transmission lines (S102). The chromatic dispersion compensation amount calculation portion 130 calculates chromatic dispersion characteristic in the front-stage and rear-stage optical transmission lines of each optical repeater 200, based on the reception wavelength information and transmission wavelength information acquired from the network control portion 120 and the carrier frequency control portion 150 and the transmission line information (distance) of the front-stage and rear-stage optical transmission line of the optical repeater 200. If the transmission information includes the structure, type, and transmission characteristics of the optical fiber, the chromatic dispersion characteristic may be determined based on this information.

For example, the chromatic dispersion characteristic is the slope of the accumulated chromatic dispersion amount with respect to the distance of the optical transmission line (chromatic dispersion characteristic as a function of distance). Since the slope of the chromatic dispersion amount varies with wavelength, a table relating the wavelength (or wavelength band) to the slope of the chromatic dispersion may be stored in advance. The chromatic dispersion compensation amount calculation portion 130 may refer to this table to determine the chromatic dispersion characteristic corresponding to the wavelength.

Next, the chromatic dispersion compensation amount calculation portion 130 of the control device 100 determines the optimal chromatic dispersion compensation amount in the optical repeater 200 (S103). The chromatic dispersion compensation amount calculation portion 130 determines the optimal chromatic dispersion compensation amount in the optical repeater 200 based on the chromatic dispersion characteristics of the front-stage and rear-stage optical transmission lines of the optical repeater 200 and the transmission line information of the front-stage and rear-stage optical transmission lines. The chromatic dispersion compensation amount calculation portion 130 calculates the chromatic dispersion amount accumulated in the optical transmission line in the front stage (reception side) and the chromatic dispersion amount accumulated in the optical transmission line in the rear stage (transmission side), and determines the optimum chromatic dispersion amount based on the front-stage and rear-stage chromatic dispersion amounts. In particular, the chromatic dispersion compensation amount calculation portion 130 determines the optimal chromatic dispersion amount based on the chromatic dispersion amount accumulated between the transmitting terminal station device 30 and the optical repeater 200 and the chromatic dispersion amount accumulated between the optical repeater 200 and the receiving terminal station device 40. For example, the chromatic dispersion compensation amount calculation portion 130 calculates the chromatic dispersion amount accumulated in the front-stage optical transmission line based on the chromatic dispersion characteristic and transmission line information (distance) of the front-stage optical transmission line of the optical repeater 200 and calculates the chromatic dispersion amount accumulated in the rear-stage optical transmission line based on the chromatic dispersion characteristic and transmission line information of the rear-stage optical transmission line of the optical repeater 200. Note that in this example, the chromatic dispersion compensation amount calculation portion 130 determines the chromatic dispersion compensation amount based on the chromatic dispersion characteristics and transmission line information, since the chromatic dispersion characteristic corresponds to wavelength information, the chromatic dispersion compensation amount may be determined based on wavelength information and transmission line information. In other words, the chromatic dispersion compensation amount calculation portion 130 may determine the chromatic dispersion compensation amount in the plurality of optical repeaters 200 comprising the path based on wavelength information and transmission line information in the path.

Next, the phase conjugation determination portion 140 of the control device 100 determines the optimal phase conjugation process in the optical repeater 200 (S104). The phase conjugation determination portion 140 determines the optimal phase conjugation process in the optical repeater 200 based on the number of optical paths between the transmitting terminal station device 30 and the receiving terminal station device 40 in the optical network 51 and the number of optical repeaters 200.

Next, the control device 100 notifies the optical repeater 200 of the routing information, reception wavelength information and transmission wavelength information determined in S101, the optimal phase conjugation processing information determined in S104, and the optimal chromatic dispersion compensation amount determined in S103 (S105).

Next, the node control portion 202 of the optical repeater 200 sets the wavelength of the wavelength information, the phase conjugation processing information, and the optimal chromatic dispersion compensation amount notified by the control device 100 (S106). The node control portion 202 sets the wavelength of the acquired reception wavelength information to the reception light source 240, the wavelength of the acquired transmission wavelength information to the transmission light source 250, the acquired phase conjugation processing information to the phase conjugation processing portion 232, and the acquired optimal chromatic dispersion compensation amount to the chromatic dispersion compensation portion 231.

Next, the optical repeater 200 performs wavelength conversion, phase conjugation processing, and chromatic dispersion compensation (S107). The reception light source 240 generates a local oscillator light r1 of the set wavelength (frequency) and the transmission light source 250 generates a transmission light r2 of the set wavelength, thereby performing wavelength conversion in the optical transmitter/receiver 201. The phase conjugation processing portion 232 performs the phase conjugation processing by phase conjugation, and the chromatic dispersion compensation portion 231 performs the chromatic dispersion compensation processing based on the set compensation amount by performing digital signal processing on the signal after the phase conjugation processing.

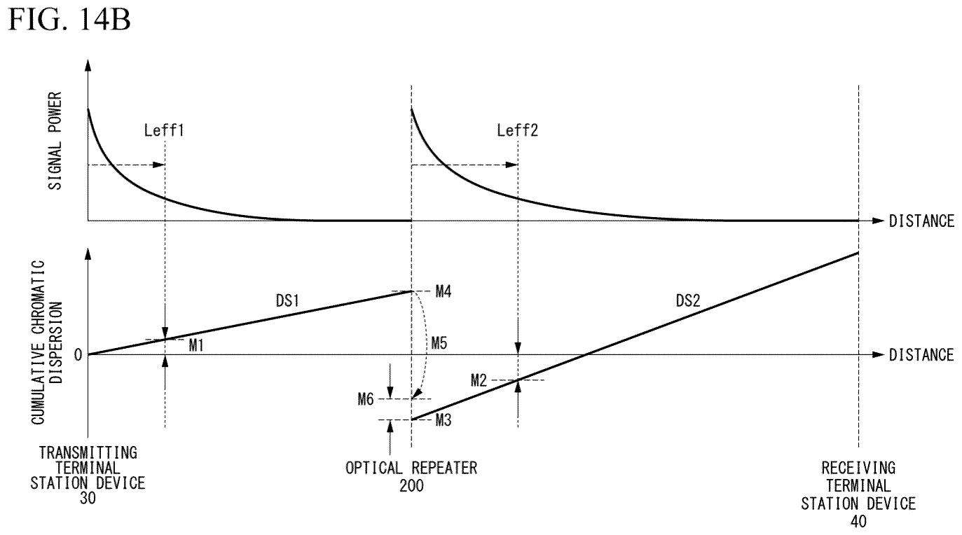

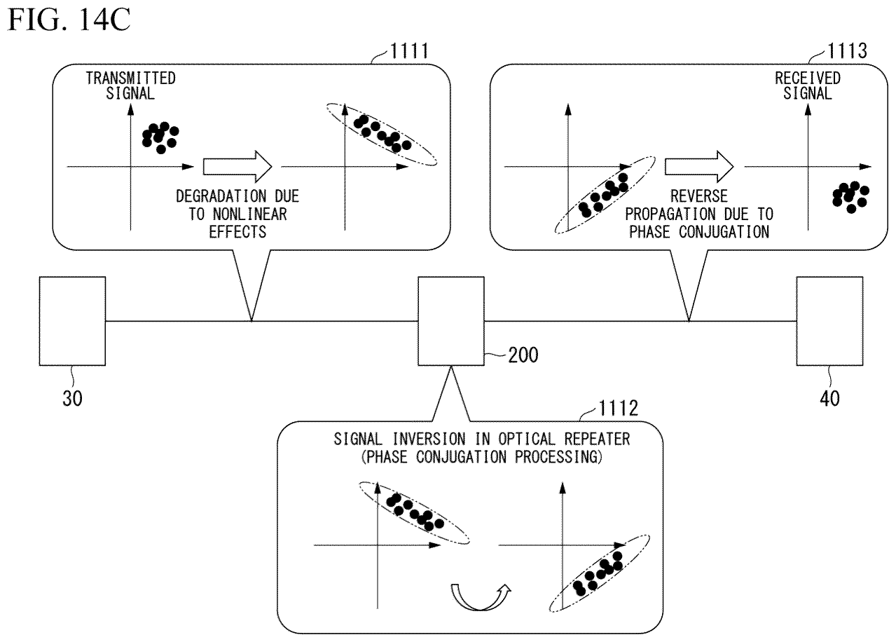

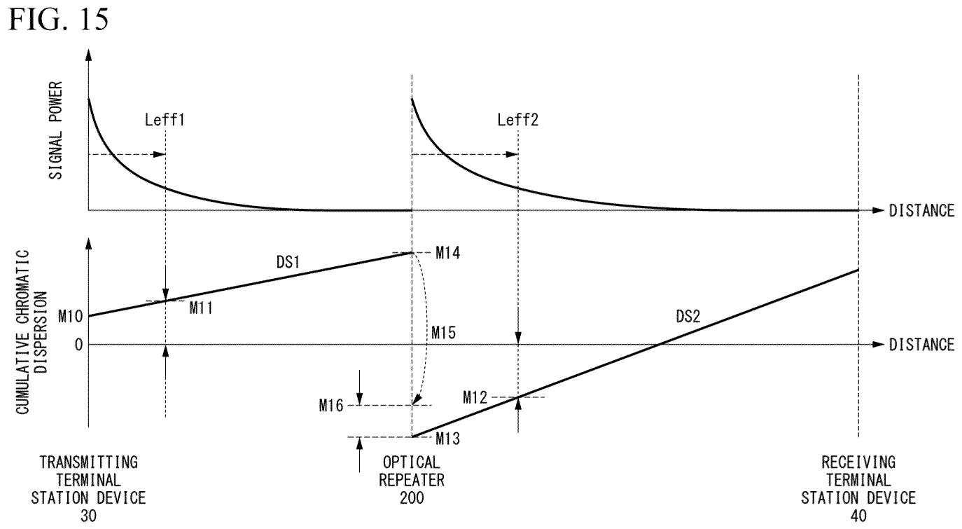

FIG. 14A and FIG. 14B show specific examples of phase conjugation processing and chromatic dispersion compensation processing by the control method of the one example embodiment of the present disclosure. In the present example embodiment, phase conjugation processing is performed in the optical repeater 200 on the nonlinear distortion accumulated in the front-stage optical transmission line in the optical signal received by the optical repeater 200. This allows the nonlinear distortion in the transmission of optical signals transmitted from the optical repeater 200 in the rear-stage optical transmission line to be cancelled out at the receiving end. To achieve this effect, the optical repeater 200 in the present example embodiment determines the optimal chromatic dispersion compensation amount such that the nonlinear distortion cancellation effect is maximized. The optimal chromatic dispersion compensation amount in this example is the compensation amount calculated based on the chromatic dispersion amount in the front-stage transmission line and the rear-stage transmission line for the optical repeater 200. In this example, the digital signal processing portion 230 of the optical repeater 200 determines the optimal chromatic dispersion compensation amount in a case where performing chromatic dispersion compensation processing after the phase conjugation processing. Even when the digital signal processing portion 230 performs phase conjugation processing after the chromatic dispersion compensation processing, it may similarly determine the optimal chromatic dispersion compensation amount based on the chromatic dispersion amount in the front-stage and rear-stage transmission lines. In this example, the phase conjugation processing is performed first in the digital signal processing portion 230, followed by the chromatic dispersion compensation processing.

As shown in FIG. 14A, in this example, one optical repeater 200 is located on the path between the transmitting terminal station device 30 and the receiving terminal station device 40. The transmitting terminal station device 30 and the optical repeater 200 are connected via the optical transmission line 3a (first optical transmission line), and the optical repeater 200 and the receiving terminal station device 40 are connected via the optical transmission line 3b (second optical transmission line). For example, the distance L1 of optical transmission line 3a and the distance L2 of optical transmission line 3b are different; with the distance L2 of the optical transmission line 3b being longer than the distance L1 of the optical transmission line 3a, but they may also be the same distance. Optical signals of wavelength λ1 are transmitted in the optical transmission line 3a, and optical signals of wavelength λ2 are transmitted in the optical transmission line 3b. For example, wavelengths λ1 and λ2 may both be in the C-band wavelength band, or they may be different, such as C-band and L-band wavelength bands, respectively, or they may both be in the L-band wavelength band. The optical repeater 200 converts the optical signal of wavelength λ1 that is received into an optical signal of wavelength λ2, and transmits the converted optical signal of wavelength λ2.

As shown in FIG. 14B, since the wavelength of the optical signal is λ1 in the front-stage optical transmission line 3a, the chromatic dispersion compensation amount calculation portion 130 of the control device 100 determines the slope DS1 of the chromatic dispersion amount in the optical transmission line 3a according to the wavelength λ1. The slope DS1 of the chromatic dispersion amount in the optical transmission line 3a may be read from a database or other storage means. The chromatic dispersion compensation amount calculation portion 130 of the control device 100 uses the slope DS1 of the chromatic dispersion amount and the effective nonlinear distance Leff1 in the optical transmission line 3a to obtain the accumulated chromatic dispersion amount M1 (=DS1×Leff1) at the effective nonlinear distance Leff1 in the front-stage optical transmission line 3a. Since nonlinear effects are effects that depend on the optical signal intensity, and the optical intensity in a transmission line decreases according to an exponential shape characterized by a propagation loss constant, it is sufficient to consider nonlinear effects only in regions of high optical intensity. The effective nonlinear distance Leff is defined as the distance at which nonlinear effects are considered, and Leff is given by the following Expression (2) using the length L and the propagation loss constant α in the optical fiber.

$$Leff = \frac{- 1 - {e}^{- α L}}{2 α} \qquad ( 2 )$$

Since the wavelength of the optical signal in the rear-stage optical transmission line 3b is λ2, the chromatic dispersion compensation amount calculation portion 130 of the control device 100 determines the slope DS2 of the chromatic dispersion amount in the optical transmission line 3b according to the wavelength λ2. The slope DS2 of the chromatic dispersion amount in optical transmission line 3b may be read from a database or other storage means. The chromatic dispersion compensation amount calculation portion 130 of the control device 100 calculates the accumulated chromatic dispersion amount M2 at the effective nonlinear distance Leff2 in the rear-stage optical transmission line 3b as M2=−M1, on the condition of having a different sign from the accumulated chromatic dispersion amount M1 at the effective nonlinear distance Leff1 in the front-stage optical transmission line 3a. The chromatic dispersion compensation amount calculation portion 130 then determines the accumulated chromatic dispersion amount M3 in the transmission signal of the optical repeater. M3 can be calculated by

$$M 3 = M 2 + D S 2 \times Leff 2 = DS 1 \times Leff 1 + DS 2 \times Leff 2 .$$

The chromatic dispersion compensation amount calculation portion 130 of the control device 100 then determines the cumulative chromatic dispersion compensation amount M5 for the optical repeater 200 to compensate chromatic dispersion using phase conjugation by M5=M4×2.

The chromatic dispersion compensation amount calculation portion 130 of the control device 100 determines the difference M6 between the accumulated chromatic dispersion amount M3 and the cumulative chromatic dispersion compensation amount M5, and transmits the difference M6 to the optical repeater 200 as the optimal chromatic dispersion compensation amount. The control device 100 also transmits control information including instructions to implement the phase conjugation process to the optical repeater 200. As a result, the node control portion 202 of the optical repeater 200 instructs the phase conjugation processing portion 232 to perform the phase conjugation processing operation based on the control information including the acquired instruction to perform the phase conjugation processing, as explained using FIGS. 9 and 11. The phase conjugation processing portion 232 performs the phase conjugation processing operations. The node control portion 202 of the optical repeater 200 sets the chromatic dispersion compensation amount M6 notified by the control device 100 to the chromatic dispersion compensation portion 231 in the digital signal processing portion 230, as described using FIG. 9. In other words, in a case where the chromatic dispersion compensation portion 231 is configured with an FDE as shown in FIG. 9, the node control portion 202 sets the transfer function coefficient of the inverse transfer function multiplication portion 413 in FIG. 9 according to the chromatic dispersion compensation amount M6 notified from the control device 100. As a result, the optical repeater 200, for the rear-stage optical transmission line 3b, calculates the cumulative chromatic dispersion M3 (M3=M4−M5−M6) after calculation of the cumulative chromatic dispersion compensation amount M5 using the phase conjugation processing of the phase conjugation processing portion 232 and the chromatic dispersion compensation using the chromatic dispersion compensation amount M6 of the chromatic dispersion compensation portion 231, and outputs an optical signal that is the cumulative chromatic dispersion M3 (FIG. 14B). This suppresses nonlinear effects in the receiving terminal station device 40.

The optical repeater 200 can calculate the accumulated chromatic dispersion amount M3 without phase conjugation by M3=M2+DS2×Leff2=DS1×Leff1+DS2×Leff2. Accordingly, the chromatic dispersion compensation portion 231 of the optical repeater 200 may calculate the relevant accumulated chromatic dispersion amount M3 and output an optical signal that is the relevant cumulative chromatic dispersion amount M3 without phase conjugation (FIG. 14B). In the explanation of FIGS. 12A and 12B, for convenience of explanation, it is explained that the optical signal of wavelength λ1 is transmitted in the optical transmission line 3a and the optical signal of wavelength λ2 is transmitted in the optical transmission line 3b, but multi-channel optical signals of multiple wavelengths k (frequency bands) may be transmitted in the optical transmission line 3a, and multi-channel optical signals of multiple wavelengths K (frequency bands) may be transmitted in the optical transmission line 3b.

FIG. 14C is a diagram showing an overview of the phase conjugation process.

As shown in FIG. 14C, at a certain span in the optical network 51 (between network devices such as the transmitting terminal station device 30 and the optical repeater 200 in FIG. 14C), nonlinear distortion of the transmitted signal occurs as signal degradation due to nonlinear effects (1111 in FIG. 14C). Phase conjugation processing (inversion of the optical signal) is performed at the optical repeater 200 (1112 in FIG. 14C). This enables the phase conjugation to be used to cancel out the nonlinear distortion in the span following the optical repeater 200 (between the optical repeater 200 and the receiving terminal station device 40), thereby reducing signal degradation (nonlinear distortion) at the receiving terminal station device 40 (1113 in FIG. 14C). In addition to this, optimal chromatic dispersion compensation for each channel's signal bandwidth in a case where the optical repeater 200 receives multi-channel signals can be used to maximize the cancellation effect of nonlinear distortion at the receiving terminal station device 40.

The aforementioned processing in the control device 100 described above is an example aspect of processing that determines the chromatic dispersion compensation amount for compensation in the optical repeater 200 based on the wavelength information of the optical signal transmitted and received by the optical repeater 200 that is included in the optical network in the optical network path and the transmission line information of the optical transmission line connected to the optical repeater 200, and determines the phase conjugation processing in the optical repeater 200 based on the wavelength information and transmission line information.

Some of the processing in the control device 100 is an example aspect of processing that transmits to the optical repeater 200 an instruction to perform phase conjugation processing to calculate the complex conjugation of the optical signal concerned based on the accumulated chromatic dispersion amount M4 of the optical signal received by the optical repeater 200.

Some of the processing in the control device 100 is an example aspect of processing that calculates the first accumulated chromatic dispersion amount M1 at a first effective nonlinear distance (Leff1) with reference to the transmission-side network device in a first optical transmission line (front-stage path) between a transmission-side network device that transmits an optical signal received by the optical repeater 200 among the optical transmission lines to which the optical repeater 200 is connected.

Some of the processing in the control device 100 is an example aspect of processing that calculates a second accumulated chromatic dispersion amount (M2) at a second effective nonlinear distance (Leff2) with reference to the own device of the optical signal in the second optical transmission line (rear-stage path) between the reception-side network device of the optical signal transmitted by the optical repeater 200 among the optical transmission lines to which the optical repeater 200 is connected, the second accumulated chromatic dispersion amount having the opposite sign (multiplied by −1) of the first accumulated chromatic dispersion amount.

Some of the processing in the control device 100 is an example aspect of processing that calculates the chromatic dispersion compensation amount (M6), which indicates the difference between the chromatic dispersion amount (M3) during transmission of an optical signal in the optical repeater 200 in a case where the accumulated chromatic dispersion amount of an optical signal becomes the second accumulated chromatic dispersion amount (M2) at the second effective nonlinear distance (Leff2) based on a statistical value (DS2) of the transition of the accumulated chromatic dispersion amount of an optical signal according to the distance in a second optical transmission line and the chromatic dispersion amount (M5) resulting from complex conjugation.

The processing of the optical repeater 200 described above is an example aspect of processing that performs chromatic dispersion compensation processing on an electrical signal based on a received optical signal, based on the chromatic dispersion compensation amount (M6), and performs phase conjugation processing on an electrical signal based on a received optical signal, based on phase conjugation processing information acquired from the control device 100.

Some of the processing described above in the optical repeater 200 is an example aspect of processing that performs phase conjugation processing based on the accumulated chromatic dispersion amount of an optical signal received by the own device and an instruction to perform phase conjugation processing in order to calculate the complex conjugation of the optical signal.

Some of the processing in the optical repeater 200 described above is an example aspect of processing to determine the chromatic dispersion amount (M3) of an optical signal transmitted to the reception-side network device, based on the chromatic dispersion amount (M5), which is the result of the complex conjugation after the phase conjugation processing, and the chromatic dispersion compensation amount (M6) acquired from the control device 100.

FIG. 15 shows another example embodiment of the chromatic dispersion compensation amount obtained by the control method in one example embodiment of the present disclosure. Unlike FIG. 14b, in this example, the transmitting terminal station device 30 transmits an optical signal with an accumulated chromatic dispersion amount M10 to the optical transmission line 3a, as shown in FIG. 15. In a case where the transmitting terminal station device 30 is the optical repeater 200 or the like in the optical network 51, dispersion such as the accumulated chromatic dispersion amount M10 may occur in an optical signal transmitted by the transmitting terminal station device 30 in this manner.

As shown in FIG. 15, since the wavelength of the optical signal is λ1 in the front-stage optical transmission line 3a of the optical repeater 200, the control device 100 determines the slope DS1 of the chromatic dispersion amount in the optical transmission line 3a according to the wavelength λ1. The control device 100 uses the effective nonlinear distance Leff1 to determine the accumulated chromatic dispersion amount M11 (=DS1×Leff1+M10) at the effective nonlinear distance Leff1 in the front-stage optical transmission line 3a.

Since the wavelength of the optical signal in the rear-stage optical transmission line 3b is λ2, the control device 100 determines the slope DS2 of the chromatic dispersion amount in the optical transmission line 3b according to the wavelength λ2. The control device 100 determines the accumulated chromatic dispersion amount M13 (=DS1×Leff1+DS2×Leff2+M10) in the transmitted signal of the optical repeater on the condition that the accumulated chromatic dispersion amount M12 at the effective nonlinear distance Leff2 in the rear-stage optical transmission line 3b is different in sign from the accumulated chromatic dispersion amount M11 at the effective nonlinear distance Leff1 in the front-stage optical transmission line 3a. The control device 100 determines the phase conjugation compensation amount M15 (=M14×2), which is compensated by the phase conjugation in the optical repeater 200.

The control device 100 determines the difference M16 between M13 and M15, and sets M6 as the optimal chromatic dispersion compensation amount to the optical repeater 200. The control device 100 performs the setting to the optical repeater 200 so as to perform the phase conjugation processing.

As described above, in the optical repeater 200 that performs wavelength conversion on a channel-by-channel basis in the present example embodiment, the analog signal output from the coherent reception front-end portion 210 is converted to a digital signal by an ADC, and after digital signal processing, is converted again to an analog signal by a DAC before being relayed back to the coherent transmission front-end portion 220. At this point, the phase conjugation processing is performed in the digital signal processing portion 230. At this time, within the digital signal processing portion 230, the chromatic dispersion distortion that occurs in the optical fiber transmission line is compensated according to the transmission line length of the network path (transmission line), the signal band and carrier frequency of the signal channel, and so on. Each carrier frequency is set so that the order of each channel is switched in the frequency domain in the coherent transmission front-end portion 220.

Specifically, the optimal chromatic dispersion compensation amount for compensation at the optical repeater is determined at the control device 100 so that the accumulated chromatic dispersion amount at the effective nonlinear distance in the front-stage transmission line and the accumulated wavelength amount at the effective nonlinear distance in the rear-stage transmission line have different signs, and chromatic dispersion compensation is performed based on the phase conjugation in the optical repeater 200, the optimal chromatic dispersion compensation amount that was determined, and the signal bandwidth and carrier frequency of the signal channel. This allows the nonlinear distortion accumulated in the front-stage optical transmission line at the receiving end of the optical repeater 200 to be offset by the optical transmission in the rear-stage optical transmission, thereby maximizing the effect of suppressing nonlinear distortion at the receiving terminal station device 40. Furthermore, as shown in FIG. 12, even when an excess dispersion amount is included in the transmitted signal by the transmitting terminal station device 30, the optical repeater 200 can set an appropriate chromatic dispersion amount to compensate for the nonlinear distortion. Moreover, the carrier frequency can be set so that the order of each channel is switched in the frequency domain in the coherent transmission front-end portion 220 to reduce inter-channel nonlinear distortion.

### Example Embodiment 2

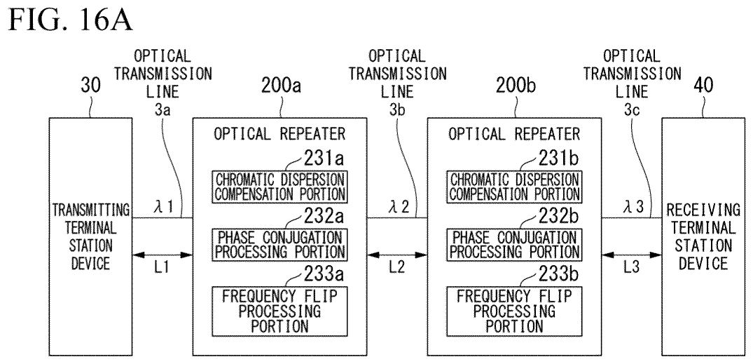

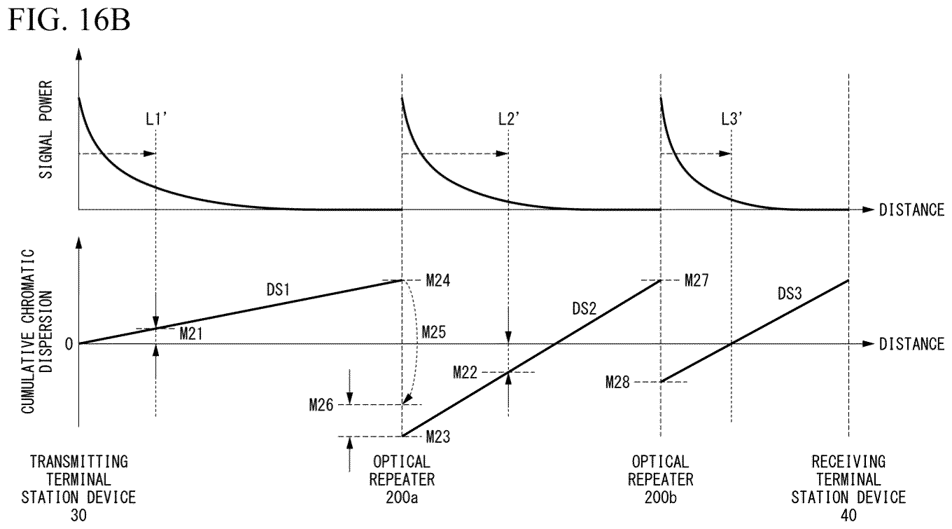

Next, Example embodiment 2 shall be explained with reference to the drawings. The configuration and basic operation of the optical network system is the same as in Example embodiment 1. FIGS. 16A and 16B show specific examples of the chromatic dispersion compensation amount according to the control method in one example embodiment of the present disclosure. This example embodiment describes an example in a case where the number of spans in the optical network is an odd number of three or more, especially in a case where the number of spans is three.

As shown in FIG. 16A, an optical repeater 200a (first optical repeater) and 200b (second optical repeater) are located on the path route between the transmitting terminal station device 30 and the receiving terminal station device 40. The transmitting terminal station device 30 and the optical repeater 200a are connected via optical transmission line 3a (first optical transmission line), the optical repeater 200a and the optical repeater 200b are connected via optical transmission line 3b (second optical transmission line), and the optical repeater 200b and receiving terminal station device 40 are connected via the optical transmission line 3c (third optical transmission line). For example, the distance L1 for optical transmission line 3a, L2 for optical transmission line 3b, and L3 for optical transmission line 3c may be different or the same distance. Optical signals of wavelength λ1 are transmitted in the optical transmission line 3a, optical signals of wavelength λ2 are transmitted in the optical transmission line 3b, and optical signals of wavelength λ3 are transmitted in the optical transmission line 3c. Multi-channel optical signals of multiple wavelengths λ (frequency bands) may be transmitted in the optical transmission line 3a, multi-channel optical signals of multiple wavelengths λ (frequency bands) may also be transmitted in the optical transmission line 3b, and multi-channel optical signals of multiple wavelengths λ (frequency bands) may also be transmitted in the optical transmission line 3c.

In a case where the total number of spans is an odd number of three or more, such as three or more total spans in Example embodiment 2, for example, the control of the control device 100 using the method of Example embodiment 1 is applied to the combination of every two spans, such as optical transmission line 3a and optical transmission line 3b, and for one optical transmission line 3 such as the remaining optical transmission line 3c, the control device 100 sets the optimum dispersion compensation amount that can suppress nonlinear distortion in a case where optically transmitting over the one span in that optical transmission line 3 (optical transmission line 3c in the present example embodiment) to the last optical repeater 200 (optical repeater 200b in the present example embodiment) that is included in the optical network 51.

As shown in FIG. 16B, the optical repeater 200a performs phase conjugation processing and calculation of the chromatic dispersion compensation amount M26 applying Example embodiment 1 based on control by the control device 100. The chromatic dispersion amount M26 after compensation in the optical repeater 200a is determined by the same method as in Example embodiment 1. The control device 100 sets the dispersion compensation amount M26 obtained by applying Example embodiment 1 to the optical repeater 200a to the optical repeater 200a. The control device 100 also performs a setting to the optical repeater 200a to perform phase conjugation processing.

The optical repeater 200b also compensates the optimum chromatic dispersion compensation amount to minimize nonlinear effects in one span of optical transmission in the optical transmission line 3c, based on the control of the control device 100. The control device 100 determines the slope DS3 of the chromatic dispersion amount in the optical transmission line 3c according to the wavelength λ3. The control device 100 determines the chromatic dispersion M28 (=DS3×L3′) of the transmission signal of the optical repeater 200b on the condition that the cumulative chromatic dispersion at the effective nonlinear distance L3′ is zero for the transmission signal in the optical transmission line 3c. The control device 100 determines the accumulated chromatic dispersion amount M27 that accumulates in the optical transmission line 3b.

The control device 100 sets the chromatic dispersion amount to be compensated in the optical repeater 200b as M27+M28 from the obtained chromatic dispersion amounts M27 and M28 to the optical repeater 200b. The control device 100 also sets the optical repeater 200b not to perform phase conjugation processing.

In the case where the total number of spans is 5 or more odd N, the control device 100, as in the case of the total number of spans of 3 shown in Example embodiment 2, identifies a combination including one optical repeater and two optical transmission lines such that Example embodiment 1 can be implemented. The control device 100 sets the phase conjugation and optimal chromatic dispersion compensation according to Example embodiment 1 for each identified combination of optical repeaters. For the remaining one optical transmission line among the N spans, the control device 100 sets the optimum chromatic dispersion compensation amount that minimizes nonlinear distortion in one span of transmission to the optical repeater.

In each optical repeater 200, a frequency flip process may be performed in the channel identified as in the other example embodiments described above.

As described above, this method suppresses nonlinear distortion at the receiving end in the case of many spans, especially in the case of an odd number of spans. Specifically, a combination including one optical repeater and two optical transmission lines is set up so that Example embodiment 1 can be implemented, and phase conjugation and chromatic dispersion compensation according to Example embodiment 1 are set up for the optical repeater in each combination. For the remaining optical transmission lines, the optimal chromatic dispersion compensation amount shown in Example embodiment 2 is set so that the nonlinear distortion is minimized in one span. Therefore, the cancellation effect of nonlinear distortion during optical transmission using chromatic dispersion compensation in an optical network including an odd number of multiple transmission lines can be maximized and the signal quality at the receiving end can be improved.

### Example Embodiment 3

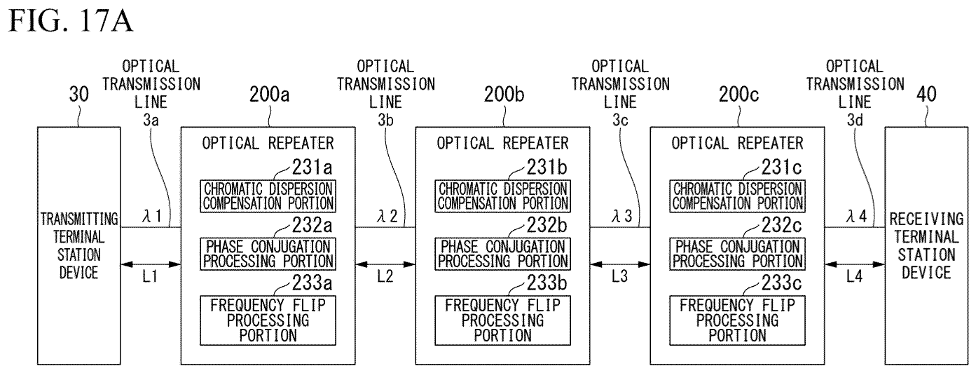

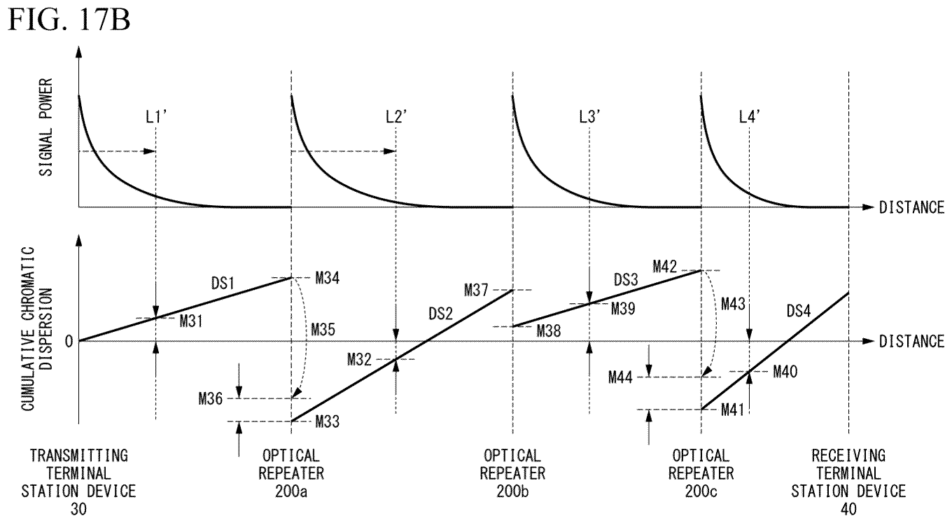

Next, Example embodiment 3 shall be explained with reference to the drawings. The configuration and basic operation of the optical network system is the same as in Example embodiment 1. FIGS. 17A and 17B show specific examples of chromatic dispersion compensation amount according to the control method in one example embodiment of the present disclosure. The present example embodiment describes an example in a case where the number of spans in the optical network is an even number of four or more, with the number of spans in the example being four.

As shown in FIG. 17A, the optical repeater 200a (first optical repeater), the optical repeater 200b (second optical repeater), and an optical repeater 200c are located on the path route between transmitting terminal station device 30 and receiving terminal station device 40. The transmitting terminal station device 30 and the optical repeater 200a are connected via the optical transmission line 3a (first optical transmission line), the optical repeater 200a and the optical repeater 200b are connected via the optical transmission line 3b (second optical transmission line), the optical repeater 200b and the optical repeater 200c are connected via the optical transmission line 3c (third optical transmission line) and the optical repeater 200b and the receiving terminal station device 40 are connected via the optical transmission line 3d (fourth optical transmission line). For example, the distance L1 of the optical transmission line 3a, distance L2 of the optical transmission line 3b, distance L3 of the optical transmission line 3c, and distance L4 of the optical transmission line 3d may be different or the same distance. Optical transmission line 3a transmits optical signals of wavelength λ1, optical transmission line 3b transmits optical signals of wavelength λ2, optical transmission line 3c transmits optical signals of wavelength λ3, and optical transmission line 3d transmits optical signals of wavelength λ4. These light wavelengths λ1 to λ4 may be the same or different for two or more wavelengths a. Multi-channel optical signals of multiple wavelengths, (frequency bands) may be transmitted in the optical transmission line 3a, multi-channel optical signals of multiple wavelengths λ (frequency bands) may be transmitted in the optical transmission line 3b, optical signals of channels of multiple wavelengths, (frequency bands) may also be transmitted in the optical transmission line 3c, and optical signals of channels of multiple wavelengths λ (frequency bands) may also be transmitted in the optical transmission line 3d.

As shown in FIG. 17B, in the case of the total number of spans of 4 in Example embodiment 3, for example, control of the control device 100 according to Example embodiment 1 is applied to the two spans of the optical transmission line 3a and the optical transmission line 3b, and control of the control device 100 according to Example embodiment 1 is applied to the two spans of the optical transmission line 3c and the optical transmission line 3d.

The control device 100 sets the dispersion compensation amount that applies the control of the control device 100 according to Example embodiment 1 and the information to perform the phase conjugation process to the optical repeater 200a. In other words, the control device 100 sets the optimum chromatic dispersion compensation amount M36 obtained by applying the control by the control device 100 of Example embodiment 1 to the optical repeater 200a. The control device 100 also sets the optical repeater 200a to perform phase conjugation processing as in Example embodiment 1.

The control device 100 sets the dispersion compensation amount obtained by applying control of the control device 100 according to Example embodiment 1 to the optical repeater 200c, and sets the information to implement the phase conjugation processing to the optical repeater 200c. In other words, the control device 100 sets the optimum chromatic dispersion compensation amount M44 obtained by applying the control by the control device 100 of Example embodiment 1 to the optical repeater 200c. The control device 100 also sets the optical repeater 200c so as to perform phase conjugation processing as in Example embodiment 1.

The control device 100 determines the slope DS2 of the chromatic dispersion amount in the optical transmission line 3b according to the wavelength λ2. The control device 100 determines the accumulated chromatic dispersion amount M37 (=DS2×L2+M33) that accumulates in the optical transmission line 3b.

The control device 100 sets the chromatic dispersion amount to be compensated by the optical repeater 200b to the optical repeater 200b as M37-M38 from the determined chromatic dispersion amount M37 and the dispersion amount M38 smaller than M37 that the transmission signal in the optical transmission line 3c has. The control device 100 also sets the optical repeater 200b not to perform phase conjugation processing.

In the case where the total number of spans is an even number of 6 or more, the control device 100, as in the case of a total span number of 4 shown in Example embodiment 3, sets a combination including one optical repeater and two optical transmission lines such that Example embodiment 1 can be implemented. The control device 100 sets the phase conjugation and optimal chromatic dispersion compensation according to Example embodiment 1 for each combination of optical repeaters.

In each optical repeater 200, a frequency flip process may be performed in the channel identified as in the other example embodiments described above.

As described above, this method compensates nonlinear distortion at the receiving end in the case of many spans, especially in the case of an even number of spans. Specifically, a combination including one optical repeater and two optical transmission lines is set so that Example embodiment 1 can be implemented, and phase conjugation and chromatic dispersion compensation according to Example embodiment 1 are set for the optical repeater in each combination. Therefore, the cancellation effect of nonlinear distortion during optical transmission using chromatic dispersion compensation in an optical network including an even number of multiple transmission lines can be maximized and the signal quality at the receiving end can be improved.

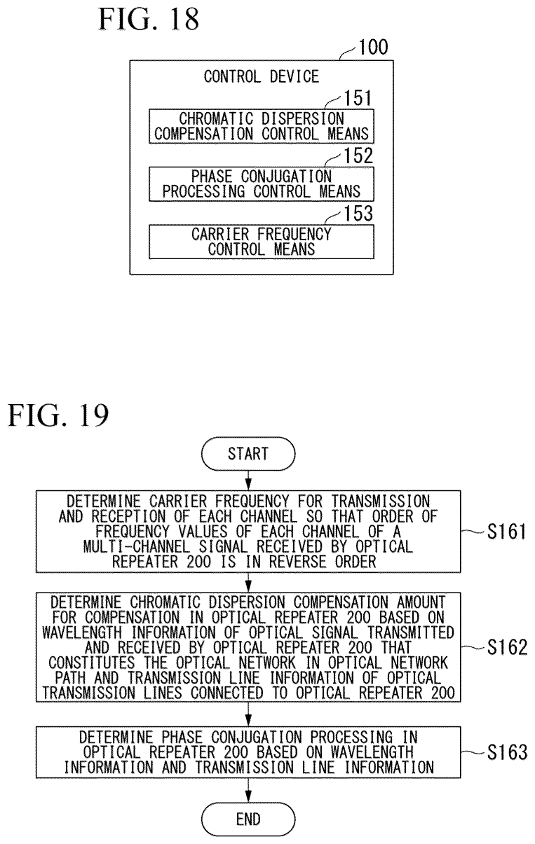

FIG. 18 is a diagram that shows another configuration of the control device.

FIG. 19 is a diagram that shows the processing flow by the control device of the other configuration.

The control device 100 is provided with at least a chromatic dispersion compensation control means 151, a phase conjugation processing control means 152, and a carrier frequency control means 153.

The carrier frequency control means 153 determines the carrier frequency for transmission and reception of each channel so that the order of the magnitude of frequency values of each channel of a multi-channel signal received by the optical repeater 200 is in reverse order (Step S161).

The chromatic dispersion compensation control means 151 determines the chromatic dispersion compensation amount for compensation in the optical repeater 200 based on the wavelength information of the optical signal transmitted and received by the optical repeater 200 that constitutes the optical network in the optical network path and the transmission line information of the optical transmission lines connected to the optical repeater 200 (Step S162).

The phase conjugation processing control means 152 determines the phase conjugation processing in the optical repeater 200 based on the wavelength information and transmission line information (Step S163).

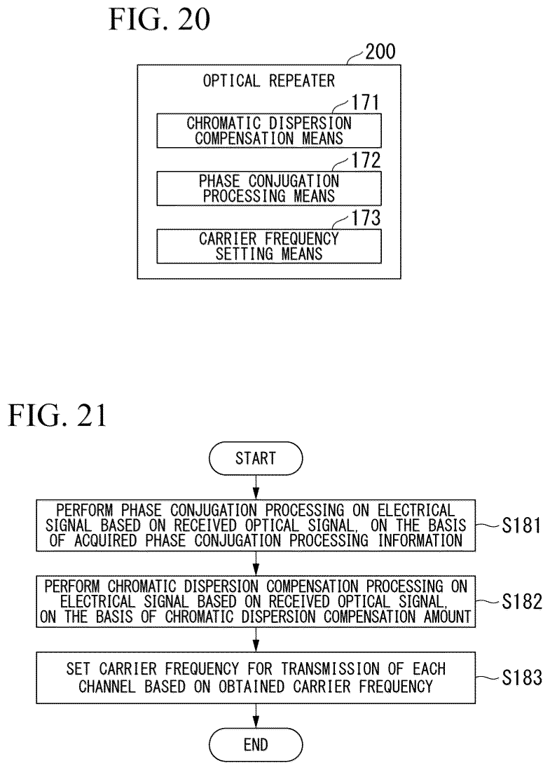

FIG. 20 is a diagram that shows another configuration of the optical repeater.

FIG. 21 is a diagram that shows the processing flow by the optical repeater of the other configuration.

The optical repeater 200 is provided with at least a chromatic dispersion compensation means 171, a phase conjugation processing means 172, and a carrier frequency setting means 173.

The phase conjugation processing means 172, on the basis of the acquired phase conjugation processing information, performs phase conjugation processing on an electrical signal based on the received optical signal (Step S181).

The chromatic dispersion compensation means 171, on the basis of the chromatic dispersion compensation amount, performs chromatic dispersion compensation processing on the electrical signal based on the received optical signal (Step S182).

The carrier frequency setting means 173 sets the carrier frequency for transmission of each channel based on the obtained carrier frequency (Step S183).

In another example embodiments, the optical repeater 200 may perform some or all of the processing of the control device 100.

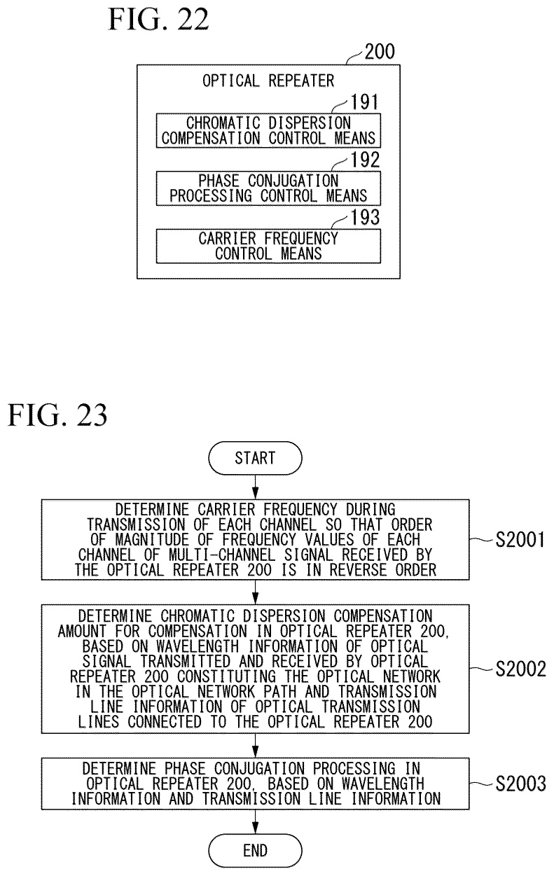

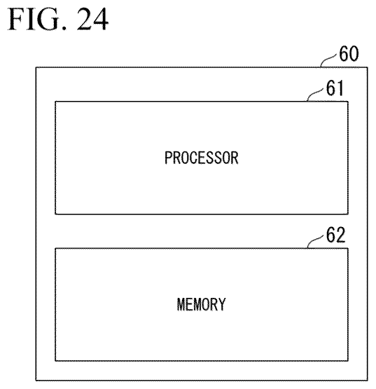

FIG. 22 is a diagram that shows another configuration of the optical repeater.

FIG. 23 is a diagram that shows the processing flow by the optical repeater of the other configuration.

In addition to the chromatic dispersion compensation means 171 and phase conjugation processing means 172 in other example embodiments, the optical repeater 200 may be further provided with a chromatic dispersion compensation control means 191, a phase conjugation processing control means 192, and a carrier frequency control means 193, as shown in FIG. 22.

The carrier frequency control means 193 determines the carrier frequency during transmission of each channel so that the order of magnitude of frequency values of each channel of the multi-channel signal received by the optical repeater 200 is in reverse order (Step S2001).

The chromatic dispersion compensation control means 191 determines the chromatic dispersion compensation amount for compensation in the optical repeater 200, based on the wavelength information of the optical signal transmitted and received by the own device (optical repeater 200) that constitutes the optical network in the optical network path and the transmission line information of the optical transmission lines connected to the optical repeater 200 (Step S2002).

The phase conjugation processing control means 192 determines the phase conjugation processing in the optical repeater 200 based on the wavelength information and the transmission line information (Step S2003).

In this case, the chromatic dispersion compensation control means 191, the phase conjugation processing control means 192, and the carrier frequency control means 193 may perform the same processing as that of the control device 100 described above. In a case where performing the processing of the chromatic dispersion compensation control means 191, the phase conjugation processing control means 192, and the carrier frequency control means 193, the optical repeater 200 may acquire from the control device 100 information necessary for the processing in the same manner as the control device 100 as described above.

In addition to the configuration of the chromatic dispersion compensation means 171, the phase conjugation processing means 172, and the carrier frequency setting means 173, the optical repeater 200 in another example embodiment may include at least one means of the chromatic dispersion compensation control means 191, the phase conjugation processing control means 192, and the carrier frequency control means 193, with the remaining means being provided in the control device 100.

The control device, optical repeater, transmitting terminal station device, and receiving terminal station device in the above example embodiments are composed of hardware or software, or both, and may be composed of one piece of hardware or software, or multiple pieces of hardware or software. Each device (control device, etc.) and each function (processing) may be realized by a computer 60 having a processor 61 such as a Central Processing Unit (CPU) and a memory 62 as a storage device, as shown in FIG. 23. For example, a program for performing the method (control method, etc.) in the example embodiments may be stored in the memory 62, and each function may be realized by executing the program stored in the memory 62 by the processor 61.

These programs contain a set of instructions (or software code) that, when read into a computer, cause the computer to perform one or more of the functions described in the example embodiments. The program may be stored in a non-transient computer readable medium or a tangible storage medium. By way of example, not limitation, computer readable media or tangible storage media include random-access memory (RAM), read-only memory (ROM), flash memory, a solid-state drive (SSD) or other memory technology, CD-ROM, digital versatile disc (DVD), Blu-ray (registered trademark) discs or other optical disc storage, magnetic cassettes, magnetic tape, magnetic disk storage, or other magnetic storage devices. The program may be transmitted on a temporary computer-readable medium or a communication medium. By way of example, not limitation, a temporary computer readable or communication medium includes electrical, optical, acoustic, or other forms of propagation signals.

Although the control device 100, optical repeater 200, transmitting terminal station device 30, and receiving terminal station device 40 of this disclosure have been described above, this disclosure is not limited to the example embodiments described above. Various changes may be made to the structure and details of this disclosure that may be understood by those skilled in the art within the scope of this disclosure. And each example embodiment can be combined with others as appropriate.

While preferred example embodiments of the disclosure have been described and illustrated above, it should be understood that these are exemplary of the disclosure and are not to be considered as limiting. Additions, omissions, substitutions, and other modifications can be made without departing from the scope of the present disclosure. Accordingly, the disclosure is not to be considered as being limited by the foregoing description, and is only limited by the scope of the appended claims.

Some or all of the above example embodiments may also be described as, but not limited to, the following supplementary notes.

### (Supplementary Note 1)

An optical network system comprising an optical repeater included in an optical network and a control device that controls the optical repeater,
wherein the control device comprises:
a management means that manages wavelength information of optical signals transmitted and received by the optical repeater in a path of the optical network and transmission line information of optical transmission lines connected to the optical repeater;
a chromatic dispersion compensation control means that determines a chromatic dispersion compensation amount for compensation in the optical repeater based on the wavelength information and the transmission line information; and
a phase conjugation processing control means that determines phase conjugation processing in the optical repeater based on the wavelength information and the transmission line information,
and the optical repeater comprises:
a chromatic dispersion compensation amount acquisition means that acquires the determined chromatic dispersion compensation amount from the control device;
a phase conjugation processing acquisition means that acquires the determined phase conjugation processing information from the control device;
a phase conjugation processing means that performs phase conjugation processing on an electrical signal according to a received optical signal based on the acquired phase conjugation processing information; and
a chromatic dispersion compensation means that performs chromatic dispersion compensation processing on an electrical signal according to a received optical signal based on the acquired chromatic dispersion compensation amount.

### (Supplementary Note 2)

The optical network system according to Supplementary Note 1, wherein the chromatic dispersion compensation control means obtains an accumulated chromatic dispersion amount at the effective nonlinear distance in the reception-side optical transmission line of the optical repeater and an accumulated chromatic dispersion amount at the effective nonlinear distance in the transmission-side optical transmission line of the optical repeater based on the reception-side wavelength information and transmission line information of the optical repeater and the transmission-side wavelength information and transmission line information of the optical repeater.

### (Supplementary Note 3)

The optical network system according to Supplementary Note 2, wherein the chromatic dispersion compensation control means determines the chromatic dispersion compensation amount based on the accumulated chromatic dispersion amount at the effective nonlinear distance in the reception-side optical transmission line of the optical repeater, the accumulated chromatic dispersion amount at the effective nonlinear distance in the transmission-side optical transmission line of the optical repeater, and a chromatic dispersion compensation amount obtained by phase conjugation processing in the optical repeater.

### (Supplementary Note 4)

The optical network system according to any one of Supplementary Note 1 to Supplementary Note 3, wherein the chromatic dispersion compensation control means determines the chromatic dispersion compensation amount based on an accumulated chromatic dispersion amount included in the transmission signal before optical transmission in the reception-side optical transmission line of the optical repeater, the accumulated chromatic dispersion amount at the effective nonlinear distance in the reception-side optical transmission line of the optical repeater, the accumulated chromatic dispersion amount at the effective nonlinear distance in the transmission-side optical transmission line of the optical repeater, and a chromatic dispersion compensation amount obtained by phase conjugation processing in the optical repeater.

### (Supplementary Note 5)

The optical network system according to any one of Supplementary Note 1 to Supplementary Note 4, wherein the chromatic dispersion compensation amount is a compensation amount obtained on the condition that the accumulated chromatic dispersion amount at the effective nonlinear distance in the reception-side optical transmission line of the optical repeater and the accumulated chromatic dispersion amount at the effective nonlinear distance in the transmission-side optical transmission line of the optical repeater have different signs.

### (Supplementary Note 6)

The optical network system according to Supplementary Note 1, wherein in an optical network comprising three or more odd-numbered paths connected via the optical repeater, the chromatic dispersion compensation control means and the phase conjugation processing control means determine the chromatic dispersion compensation amount and the phase conjugation processing in a target optical repeater based on the wavelength information and the transmission line information in the paths before and after the target optical repeater other than the optical repeater connected to the last path among the plurality of paths.

### (Supplementary Note 7)

The optical network system according to any one of Supplementary Note 1 to Supplementary Note 6, wherein the chromatic dispersion compensation control means and the phase conjugation processing control means obtain, in the optical repeater, a combination including a pair of two paths in the front and rear stages and one optical repeater repeating the paths, and one remaining path, and determine the optical repeater other than the optical repeater connected to the remaining path as the target optical repeater.

### (Supplementary Note 8)

The optical network system according to Supplementary Note 7, wherein the phase conjugation processing control means determines the phase conjugation processing in the optical repeater in the combination.

### (Supplementary Note 9)

The optical network system according to either one of Supplementary Note 7 and Supplementary Note 8, wherein the chromatic dispersion compensation control means determines the chromatic dispersion compensation amount in the optical repeater of the combination based on the wavelength information and transmission line information in the two optical transmission lines of the combination.

### (Supplementary Note 10)

The optical network system according to Supplementary Note 7, wherein the chromatic dispersion compensation control means determines the chromatic dispersion compensation amount in an optical repeater of the one remaining path based on the wavelength information and transmission line information in the optical transmission line of the remaining path.

### (Supplementary Note 11)

The optical network system according to any one of Supplementary Note 7 to Supplementary Note 10, wherein the chromatic dispersion compensation amount is the compensation amount obtained on the condition that the accumulated chromatic dispersion at the effective nonlinear distance in the optical transmission line of the one remaining path becomes zero.

### (Supplementary Note 12)

The optical network system according to any one of Supplementary Note 7 to Supplementary Note 11, wherein in an optical network comprising four or more even-numbered paths connected via the optical repeater, the chromatic dispersion compensation control means and the phase conjugation processing control means determine the chromatic dispersion compensation amount and the phase conjugation processing in the optical repeater based on the wavelength information and the transmission line information in the paths before and after each optical repeater in a plurality of the paths.

### (Supplementary Note 13)

The optical network system according to any one of Supplementary Note 1 to Supplementary Note 12, wherein the chromatic dispersion compensation control means and the phase conjugation processing control means obtain a combination of two optical transmission lines and one optical repeater as a pair in the optical repeater.

### (Supplementary Note 14)

The optical network system according to any one of Supplementary Note 7 to Supplementary Note 13, wherein the phase conjugation processing control means determines the phase conjugation processing for the optical repeater in the combination.

### (Supplementary Note 15)

The optical network system according to any one of Supplementary Note 7 to Supplementary Note 14, wherein the chromatic dispersion compensation control means determines the chromatic dispersion compensation amount in the optical repeater of the combination based on the wavelength information and transmission line information in the two optical transmission lines of the combination.

### (Supplementary Note 16)

A control method comprising:
managing wavelength information of optical signals transmitted and received by an optical repeater in a path of an optical network, transmission line information of optical transmission lines connected to the optical repeater, and the number of paths of the optical network; and
determining a chromatic dispersion compensation amount for compensation and phase conjugation processing in the optical repeater based on the wavelength information, the transmission line information, and the number of paths in the optical network.

### (Supplementary Note 17)

The control method according to Supplementary Note 16 further comprising
determining the chromatic dispersion compensation amount and phase conjugation processing based on an accumulated chromatic dispersion amount at the effective nonlinear distance in the reception-side optical transmission line of each optical repeater in the optical network path and an accumulated chromatic dispersion amount at the effective nonlinear distance in the transmission-side optical transmission line of the optical repeater.

### (Supplementary Note 18)

A control program for causing a computer to execute:
managing wavelength information of optical signals transmitted and received by an optical repeater in a path of an optical network, transmission line information of optical transmission lines connected to the optical repeater, and the number of paths of the optical network; and
determining a chromatic dispersion compensation amount for compensation and phase conjugation processing in the optical repeater based on the wavelength information, the transmission line information, and the number of paths in the optical network.

### (Supplementary Note 19)

The program according to Supplementary Note 18 further comprising determining the chromatic dispersion compensation amount and phase conjugation processing based on an accumulated chromatic dispersion amount at the effective nonlinear distance in the reception-side optical transmission line of each optical repeater in the optical network path and an accumulated chromatic dispersion amount at the effective nonlinear distance in the transmission-side optical transmission line of the optical repeater.

### (Supplementary Note 20)

A control device comprising:
a chromatic dispersion compensation control means that determines a chromatic dispersion compensation amount for compensation in an optical repeater based on wavelength information of optical signals transmitted and received by the optical repeater constituting an optical network in the path of the optical network, and transmission line information of optical transmission lines connected to the optical repeater; and
a phase conjugation processing control means that determines phase conjugation processing in the optical repeater based on the wavelength information and the transmission line information.

### (Supplementary Note 21)

The control device according to Supplementary Note 20, wherein the phase conjugation processing control means transmits an instruction to the optical repeater to implement the phase conjugation processing to calculate complex conjugation of the optical signal.

### (Supplementary Note 22)

The control device according to Supplementary Note 21, wherein the chromatic dispersion compensation control means:
calculates a first accumulated chromatic dispersion amount at a first effective nonlinear distance with reference to the transmission-side network device in a first optical transmission line between a transmission-side network device that transmits an optical signal received by the optical repeater among the optical transmission lines to which the optical repeater is connected;
calculates a second accumulated chromatic dispersion amount in a second effective nonlinear distance with reference to the own device of the optical signal in the second optical transmission line between the reception-side network device of an optical signal transmitted by the optical repeater among the optical transmission lines to which the optical repeater is connected, the second accumulated chromatic dispersion amount having the opposite sign of the first accumulated chromatic dispersion amount; and
calculates the chromatic dispersion compensation amount indicating the difference between the chromatic dispersion amount during transmission of the optical signal in the optical repeater in a case where the accumulated chromatic dispersion amount of the optical signal becomes the second accumulated chromatic dispersion amount at the second effective nonlinear distance based on a statistical value of the transition of the accumulated chromatic dispersion amount of the optical signal according to the distance in the second optical transmission line, and the chromatic dispersion amount resulting from the complex conjugation.

### (Supplementary Note 23)

An optical repeater indicating communicative connection of the own device with a control device comprising:
a chromatic dispersion compensation control means that determines a chromatic dispersion compensation amount for compensation in the own device based on wavelength information of an optical signal transmitted and received by the own device, which is included in the optical network in the optical network path, and transmission line information of optical transmission lines connected to the own device; and
a phase conjugation processing control means that determines phase conjugation processing in the own device based on the wavelength information and the transmission line information,
the optical repeater comprising:
a phase conjugation processing means that performs phase conjugation processing on an electrical signal according to a received optical signal based on the phase conjugation processing information acquired from the control device; and
a chromatic dispersion compensation means that performs chromatic dispersion compensation processing on an electrical signal according to a received optical signal based on the chromatic dispersion compensation amount.

### (Supplementary Note 24)

The optical repeater according to Supplementary Note 23, wherein the phase conjugation processing means performs the phase conjugation processing based on an instruction to implement the phase conjugation processing to calculate complex conjugation of the optical signal.

### (Supplementary Note 25)

The optical repeater according to Supplementary Note 24, comprising a chromatic dispersion compensation means that:
calculates a first accumulated chromatic dispersion amount at the first effective nonlinear distance with reference to the transmission-side network device in a first optical transmission line between a transmission-side network device that transmits an optical signal received by the optical repeater among the optical transmission lines to which the optical repeater is connected;
calculates a second accumulated chromatic dispersion amount in a second effective nonlinear distance with reference to the own device of the optical signal in a second optical transmission line between a reception-side network device of an optical signal transmitted by the optical repeater among the optical transmission lines to which the optical repeater is connected, the second accumulated chromatic dispersion amount having the opposite sign of the first accumulated chromatic dispersion amount;
communicatively connects with control that calculates the chromatic dispersion compensation amount indicating the difference between the chromatic dispersion amount during transmission of the optical signal in the optical repeater in a case where the accumulated chromatic dispersion amount of the optical signal becomes the second accumulated chromatic dispersion amount at the second effective nonlinear distance based on a statistical value of the transition of the accumulated chromatic dispersion amount of the optical signal according to the distance in the second optical transmission line, and the chromatic dispersion amount resulting from the complex conjugation; and
determines a chromatic dispersion amount of an optical signal transmitted to the reception-side network device based on the chromatic dispersion amount, which is the result of the complex conjugation after the phase conjugation processing, and the chromatic dispersion compensation amount acquired from the control device.

### (Supplementary Note 26)

An optical repeater comprising:
a digital signal processing means that performs channel-by-channel frequency flip processing on at least one or more optical signal channels.

### (Supplementary Note 27)

The optical repeater according to Supplementary Note 26, wherein the digital signal processing means performs the frequency flip processing on all channels of the optical signal on a per-channel basis.

### (Supplementary Note 28)

The optical repeater according to Supplementary Note 26 or Supplementary Note 27, wherein the digital signal processing means sequentially identifies, among the plurality of channels with different frequency bands, those to be processed and those not to be processed among the multiple channels arranged in sequence based on the frequency band, and performs the frequency flip processing on the channels to be processed.

### (Supplementary Note 29)

The optical repeater according to any one of supplementary notes 26 to 28, wherein the digital signal processing means performs said frequency flip processing, which inverts the frequency component of an optical signal for each frequency, based on a reference frequency set at the center in the frequency band.

### (Supplementary Note 30)

The optical repeater according to any one of supplementary notes 26 to 29, wherein the digital signal processing means comprises:
a phase conjugation processing means that performs phase conjugation processing on an electrical signal based on a received optical signal;
a chromatic dispersion compensation means that performs chromatic dispersion compensation processing on the electrical signal based on the received optical signal; and
the frequency flip processing means that performs the frequency flip processing.

### (Supplementary Note 31)

The optical repeater according to any one of supplementary notes 26 to 30, wherein the frequency flip processing means performs the phase conjugation processing and the chromatic dispersion compensation processing for all optical signal channels, and performs the frequency flip processing on a per-channel basis on at least one or more channels.

### (Supplementary Note 32)

An optical repeater comprising:
a chromatic dispersion compensation processing means that performs chromatic dispersion compensation processing on an electrical signal based on a received optical signal, the processing being based on a carrier frequency and frequency band of the relevant channel among a plurality of channels included in the optical signal; and
a phase conjugation processing means that performs phase conjugation processing on the electrical signal based on the received optical signal.

### (Supplementary Note 33)

The optical repeater according to Supplementary Note 32, wherein the chromatic dispersion compensation processing means performs chromatic dispersion compensation processing based on the frequency domain of the relevant channel, among the frequency bands of all channels of the plurality of channels with different frequency bands.

### (Supplementary Note 34)

The optical repeater according to Supplementary Note 32 or Supplementary Note 33, wherein the chromatic dispersion compensation processing means performs chromatic dispersion compensation processing based on the frequency domain of the relevant channel, among the frequency bands of all channels of the plurality of channels with different frequency bands, before or after the phase conjugation process.

### (Supplementary Note 35)

The optical repeater according to any one of supplementary notes 32 to 34, further comprising
a carrier frequency control means that performs carrier frequency control that changes the frequency of a plurality of channels included in the optical signal.

### (Supplementary Note 36)

The optical repeater according to Supplementary Note 35, wherein the carrier frequency control means identifies the order of multiple channels arranged sequentially based on the frequency bands among the plurality of channels with different frequency bands, and determines the carrier frequency during transmission of the plurality of channels so that the order of the channels is reversed.

### (Supplementary Note 37)

The optical repeater according to Supplementary Note 35 or Supplementary Note 36, wherein the carrier frequency control means identifies the order of multiple channels arranged sequentially based on the frequency bands among the plurality of channels with different frequency bands, determines the carrier frequency during transmission of the plurality of channels so that the order of the channels is reversed, and further applies a fixed frequency offset to each of the channels.

### (Supplementary Note 38)

An optical repeating method comprising
performing chromatic dispersion compensation processing on an electrical signal based on a received optical signal, the processing being based on a carrier frequency and frequency band of the relevant channel among a plurality of channels included in the optical signal, and performs phase conjugation processing on the electrical signal based on the received optical signal.

### (Supplementary Note 39)

The optical repeating method according to Supplementary Note 38 further comprising
performing carrier frequency control that changes the frequency of a plurality of channels included in the optical signal.

### (Supplementary Note 40)

The optical repeating method according Supplementary Notes 38 or Supplementary Note 39 further comprising
performing the chromatic dispersion compensation processing based on the frequency domain of the relevant channel, among the frequency bands of all channels of the plurality of channels with different frequency bands.

### (Supplementary Note 41)

The optical repeating method according to any one of supplementary notes 38 to 40 further comprising
performing chromatic dispersion compensation processing based on the frequency domain of the relevant channel, among the frequency bands of all channels of the plurality of channels with different frequency bands, before or after the phase conjugation process.

### (Supplementary Note 42)

The optical repeating method according to any one of supplementary notes 38 to 41 further comprising
identifying the order of multiple channels arranged sequentially based on the frequency bands among the plurality of channels with different frequency bands, and determines the carrier frequency during transmission of the plurality of channels so that the order of the channels is reversed.

### (Supplementary Note 43)

The optical repeating method according to any one of supplementary notes 38 to 42 further comprising
identifying the order of multiple channels arranged sequentially based on the frequency bands among the plurality of channels with different frequency bands, determines the carrier frequency during transmission of the plurality of channels so that the order of the channels is reversed, and further applies a fixed frequency offset to each of the channels.

### (Supplementary Note 44)

A program for causing an optical repeater to function as:
a chromatic dispersion compensation processing means that performs chromatic dispersion compensation processing on an electrical signal based on a received optical signal, the processing being based on a carrier frequency and frequency band of the relevant channel among a plurality of channels included in the optical signal; and
a phase conjugation processing means that performs phase conjugation processing on the electrical signal based on the received optical signal.

### (Supplementary Note 45)

The program according to Supplementary Note 44 for causing an optical repeater to function as:
a carrier frequency control means that performs carrier frequency control that changes the frequency of a plurality of channels included in the optical signal.

### (Supplementary Note 46)

The program according to Supplementary Note 44 or Supplementary Note 45, wherein the chromatic dispersion compensation processing means performs chromatic dispersion compensation processing based on the frequency domain of the relevant channel, among the frequency bands of all channels of the plurality of channels with different frequency bands.

### (Supplementary Note 47)

The program according to any one of supplementary notes 44 to 46, wherein the chromatic dispersion compensation processing means performs chromatic dispersion compensation processing based on the frequency domain of the relevant channel, among the frequency bands of all channels of the plurality of channels with different frequency bands, before or after the phase conjugation process.

### (Supplementary Note 48)

The program according to Supplementary Note 45, wherein the carrier frequency control means identifies the order of multiple channels arranged sequentially based on the frequency bands among the plurality of channels with different frequency bands, and determines the carrier frequency during transmission of the plurality of channels so that the order of the channels is reversed.

### (Supplementary Note 49)

The program according to Supplementary Note 45 or Supplementary Note 48 wherein the carrier frequency control means identifies the order of multiple channels arranged sequentially based on the frequency bands among the plurality of channels with different frequency bands, determines the carrier frequency during transmission of the plurality of channels so that the order of the channels is reversed, and further applies a fixed frequency offset to each of the channels.

What is claimed is:

1. An optical repeater comprising:
at least one memory configured to store instructions; and
at least one processor configured to execute the instructions to:
perform chromatic dispersion compensation processing on an electrical signal based on a received optical signal, the processing being based on a carrier frequency and frequency band of a relevant channel among a plurality of channels included in the optical signal; and
perform phase conjugation processing on the electrical signal based on the received optical signal.

2. The optical repeater according to claim 1, wherein the at least one processor is configured to execute the instructions to perform chromatic dispersion compensation processing based on the frequency domain of the relevant channel, among the frequency bands of all channels of the plurality of channels with different frequency bands.

3. The optical repeater according to claim 2, wherein the at least one processor is configured to execute the instructions to perform chromatic dispersion compensation processing based on the frequency domain of the relevant channel, among the frequency bands of all channels of the plurality of channels with different frequency bands, before or after the phase conjugation process.

4. The optical repeater according to claim 3, wherein the at least one processor is configured to execute the instructions to perform carrier frequency control that changes the frequency of a plurality of channels included in the optical signal.

5. The optical repeater according to claim 4, wherein the at least one processor is configured to execute the instructions to:
identify the order of multiple channels arranged sequentially based on the frequency bands among the plurality of channels with different frequency bands; and
determine the carrier frequency during transmission of the plurality of channels so that the order of the channels is reversed.

6. The optical repeater according to claim 5, wherein the at least one processor is configured to execute the instructions to:
identify the order of multiple channels arranged sequentially based on the frequency bands among the plurality of channels with different frequency bands;
determines the carrier frequency during transmission of the plurality of channels so that the order of the channels is reversed; and
apply a fixed frequency offset to each of the channels.

7. An optical repeating method comprising
performing chromatic dispersion compensation processing on an electrical signal based on a received optical signal, the processing being based on a carrier frequency and frequency band of a relevant channel among a plurality of channels included in the optical signal, and performs phase conjugation processing on the electrical signal based on the received optical signal.

8. The optical repeating method according to claim 7, further comprising
performing carrier frequency control that changes the frequency of a plurality of channels included in the optical signal.

9. The optical repeating method according to claim 7, further comprising
performing the chromatic dispersion compensation processing based on the frequency domain of the relevant channel, among the frequency bands of all channels of the plurality of channels with different frequency bands.

10. The optical repeating method according to claim 7, further comprising
performing chromatic dispersion compensation processing based on the frequency domain of the relevant channel, among the frequency bands of all channels of the plurality of channels with different frequency bands, before or after the phase conjugation process.

11. The optical repeating method according to claim 7, further comprising
identifying the order of multiple channels arranged sequentially based on the frequency bands among the plurality of channels with different frequency bands, and determines the carrier frequency during transmission of the plurality of channels so that the order of the channels is reversed.

12. The optical repeating method according to claim 7, further comprising
identify the order of multiple channels arranged sequentially based on the frequency bands among the plurality of channels with different frequency bands, determines the carrier frequency during transmission of the plurality of channels so that the order of the channels is reversed, and further applies a fixed frequency offset to each of the channels.

13. A non-transitory storage medium storing a program for causing an optical repeater to execute:
performing chromatic dispersion compensation processing on an electrical signal based on a received optical signal, the processing being based on a carrier frequency and frequency band of a relevant channel among a plurality of channels included in the optical signal; and
performing phase conjugation processing on the electrical signal based on the received optical signal.

14. The non-transitory storage medium according to claim 13, wherein the program further causes the optical repeater to execute performing carrier frequency control that changes the frequency of a plurality of channels included in the optical signal.

15. The non-transitory storage medium according to claim 14, wherein the program further causes the optical repeater to execute performing chromatic dispersion compensation processing based on the frequency domain of the relevant channel, among the frequency bands of all channels of the plurality of channels with different frequency bands.

16. The non-transitory storage medium according to claim 13, wherein the program further causes the optical repeater to execute performing chromatic dispersion compensation processing based on the frequency domain of the relevant channel, among the frequency bands of all channels of the plurality of channels with different frequency bands, before or after the phase conjugation process.

17. The non-transitory storage medium according to claim 13, wherein the program further causes the optical repeater to execute:
identifying the order of multiple channels arranged sequentially based on the frequency bands among the plurality of channels with different frequency bands; and
determining the carrier frequency during transmission of the plurality of channels so that the order of the channels is reversed.

18. The non-transitory storage medium according to claim 13, wherein the program further causes the optical repeater to execute:
identifying the order of multiple channels arranged sequentially based on the frequency bands among the plurality of channels with different frequency bands,
determining the carrier frequency during transmission of the plurality of channels so that the order of the channels is reversed; and
applying a fixed frequency offset to each of the channels.
